(19) United States
(12) Patent Application Publication
(10) Pub. No.: US 2021/0160996 A1
(43) Pub. Date: May 27, 2021

(54) HEAVY OIL CRACKING DEVICE SCALEUP WITH MULTIPLE ELECTRICAL DISCHARGE MODULES

(71) Applicant: The Texas A&M University System, College Station, TX (US)

(72) Inventors: Kunpeng Wang, College Station, TX (US); David Staack, College Station, TX (US); Howard Jemison, Houston, TX (US); Shariful Islam Bhuiyan, College Station, TX (US); Charles Martens, Houston, TX (US)

(21) Appl. No.: 17/048,635

(22) PCT Filed: Apr. 19, 2019
(86) PCT No.: PCT/US19/28336

§ 371 Date: Oct. 19, 2020

Related U.S. Application Data
(60) Provisional application No. 62/660,619, filed on Apr. 20, 2018.

(51) Int. Cl. H05H 1/48; C10G 15/12; F23Q 5/00

(52) U.S. Cl. CPC H05H 1/48; B01J 2219/0898; F23Q 5/00; C10G 15/12

(57) ABSTRACT

Provided is an approach for scaling up a multiphase plasma chemical reactor that uses gas bubble discharge in liquids. One example involves single spark gap discharge scale up systems and processes with suitable characteristic parameters. Scaling parameters are based on the size change of one spark gap. Another example involves scale-up systems and processes that can be applied to multiple spark gaps with multiple discharge modules and its dimension information. Numbers of modules and resulting device sizes could be based on required production rate and specific energy input. Applications allow for scaling up of any plasma chemical system or process with similar mechanisms and reactors, such oil treatment reactors.

### CROSS REFERENCE TO RELATED APPLICATION

This application claims priority to U.S. Provisional Patent Application No. 62/660,619 entitled “HEAVY OIL CRACKING DEVICE SCALEUP WITH MULTIPLE ELECTRICAL DISCHARGE MODULES,” filed Apr. 20, 2018, and incorporated herein by reference in its entirety.

### FIELD

The present technology generally relates to a process for cracking crude oil and other heavy liquid hydrocarbon materials using a spark discharge, and specifically relates to scaling up multiple spark gap reactors used in heavy oil cracking, with multiple electrical discharge modules. The disclosed approach is further applicable to scaling up of plasma chemical reactors that generate plasma in liquids for materials processing or upgrading.

### BACKGROUND

The oil and gas industry can be divided into three chronological sectors: upstream, midstream and downstream. The upstream sector involves the exploration and production section. It involves searching, producing and recovering crude oil and/or natural gas from underground or underwater fields. It also covers the process of drilling and operation of wells that recover and bring crude oil and raw gas to the surface. The exploration includes conducting geological and geophysical surveys, searching for potential underground or underwater crude oil and natural gas fields, obtaining leases and permissions for drilling and the entire process of drilling.

The midstream sector involves the transportation of crude or refined petroleum products, usually via pipeline, oil tanker, barge, truck or rail. The final destination is refineries which then commence the downstream process. The midstream sector also includes the storage of these products as well as any wholesale marketing efforts. The midstream sector can also comprise of upstream and downstream elements due to its median positioning. For example, the midstream sector may include natural gas processing plants that purify the raw natural gas as well as removing and producing elemental sulfur and natural gas liquids (NGL) as finished end-products.

Recently, due to the rising price of crude oil, declining reserves of medium and light crude oil and abundance of unconventional crudes, the heavy crude oil and bitumen reserve exploitation is considerably favored. However, heavy crude oil and bitumen has many challenges to overcome, both in its production and in its transportation to refineries. Transporting heavy crude oil via pipeline is difficult due to its high density and viscosity (>1000 cP) and low mobility at reservoir temperature. Furthermore, contaminants like asphaltene deposition, heavy metals, sulphur and brine or salt make it difficult to be transported and refined using conventional refinery methods. Presence of brine or salt in heavy crude results in corrosion of the pipeline. In some cases, it may result in the formation of an emulsion such as oil-water mixture which makes transportation difficult. Due to the heavy molecular weight and high viscosity of heavy crude, a high pressure drop along the pipeline is expected making it costly and energy intensive. Furthermore, asphaltene deposition cases clogging in walls, decreasing the cross-sectional area available for oil flow.

Hence to address these problems and transport heavy crude further processes are carried out. They include:
viscosity reduction e.g. preheating of the heavy crude oil and bitumen and subsequent heating of the pipeline, blending and dilution with light hydrocarbons or solvent. The viscosity of the blended mixture is determined by the diluent added and its rate. The dilution of the heavy crude requires two pipelines, one for the oil and other for the diluents, further adding additional costs.
emulsification through the formation of an oil-in-water
drag/friction reduction (e.g. pipeline lubrication through the use of core-annular flow, drag reducing additive)
in situ partial upgrading of the heavy crude to produce a Syncrude with improved viscosity, American Petroleum Institute (API) gravity, and minimized asphaltenes, sulfur and heavy metal content.

Partial upgrading of heavy oil involves conversion of only a portion of the vacuum residue and production of synthetic crude oil (SCO) containing 5-25% residue. They can be developed for half the cost of full upgrading but are not commercialized due to lack of technology, issues related to stability and the economics of SCO. However, in countries like Canada, due to their huge heavy crude oil resources, partial upgrading is becoming a viable option.

The downstream sector is the last stage of oil and gas industry. It includes the refining of petroleum crude oil and the processing and purifying of raw natural gas. The marketing and distribution of products derived from crude oil and natural gas are also a part of this sector. The products delivered to normal consumers include gasoline or petrol, kerosene, jet fuel, diesel oil, heating oil, fuel oil, lubricant, waxes, asphalt, natural gas and liquefied petroleum gas (LPG) as well as hundreds of petrochemicals.

In a standard oil refining process, the crude oil is desalted and passed through the atmospheric distillation that separates the it into fractions based on their range of boiling points. The atmospheric residue (AR) cut off temperature is about 350-360° C. Fractions below these boil off and are separated whereas the residue from atmospheric distillation containing longer carbon chains require further distillation at a reduced pressure and high temperature. Hence comes the vacuum distillation process that is important for further upgrading of crude oil and extract oils. The vacuum residue (VR) cut-off temperature is approximately 565° C.

However, despite AR and VR treatments, refineries that process heavier crude will still have significant fraction of the incoming crude as residue (e.g., the Lloydminster Blend residue is approximately 50% at 460° C.). Therefore, further several processes are required to crack the heavy oil. Currently there are several technologies available for the cracking of crude oil. Of these, thermal cracking is considered to be the most efficient and is widely used for converting heavy, higher molecular weight hydrocarbons into lighter, lower molecular weight fractions.

The most commonly used cracking technologies are hydrocracking, fluid catalytic cracking and delayed coker. While all of these cracking processes are associated with some advantages, they come with significant drawbacks as well. General advantages include the ability to produce different types of fuel ranging from light aviation kerosene to heavy fuel oils in large quantities.

However, a significant disadvantage of the currently employed methods for synthesizing lighter fuels from crude oil is the high financial cost associated with the realization of the technology. Both capital and operating cost are typically high for these methods. Also due to the economy of scaling, all thermal processing is most efficient only at large volume to surface area. It is estimated that the minimum efficient scale for a full range refinery is approximately 200 thousand barrels per day (MBD) of crude oil capacity.

In particular, the existing technology is realized at high temperatures and pressures of the working medium and therefore requires specialty materials for the manufacture of chemical reactors and other special equipment. For example, the reactors are typically made from special grade alloy steels. Another factor that adds up to the huge costs of these processes is the H2 embrittlement and its quality control. Hydrogen embrittlement is the process by which hydride-forming metals such as titanium, vanadium, zirconium, tantalum, and niobium become brittle and fracture due to the introduction and subsequent diffusion of hydrogen into the metal.

The operating conditions for a single stage hydrocracker is 660-800° F. (348-427° C.) with increasing 0.1-0.2° F. (about 0.05-0.1° C.) per day to offset loss of catalyst activity and pressure ranging from 1200 to 2000 psig. A fuel coker works at 910-930° F. (487-500° C.) with 15 psig typical pressures. For the fluid catalytic cracker, the reactor and regenerator are considered to be the heart of the fluid catalytic cracking unit. The reactor is at a temperature of about 535° C. and a pressure of about 25 psig while the regenerator for the catalyst operates at a temperature of about 1320° F. (715° C.) and a pressure of about 35 psig. These operating conditions are very expensive to maintain.

Also, the capital cost of a reforming unit like hydrocracker is highly expensive. It is estimated that a hydrocracker requires five times the capital cost of atmospheric distillations. For example, if a crude distillation unit of 100,000 b/d capacity costs approximately $90 million to build, its hydrocracker with a complexity number of 5 will require $450 million to process the same capacity oil.

Additionally, the catalysts used in FCC processes are highly sensitive to the content of various impurities in the crude oil. The presence of sulfur in the crude oil in particular leads to rapid degradation of the catalytic properties of the catalyst. Thus pretreatment (desulfurization) of the feedstock needs to be done that increases the weightage of the cost. Moreover, nickel, vanadium, iron, copper and other contaminants that are present in FCC feedstocks, all have deleterious effects on the catalyst activity and performance. Nickel and vanadium are particularly troublesome. Further, withdrawing some of the circulating catalyst as a spent catalyst and replacing them with fresh catalyst in order to maintain desired level of activity for FCC technology, adds to the operational cost of the process.

Plasma chemical methods use various types of electrical discharges to create plasma. Such methods of oil cracking and reforming have been described in various patents and publications. For example, U.S. Patent Publication No. 2005/0121366 discloses a method and apparatus for reforming oil by passing electrical discharge directly through the liquid. The disadvantage of this method is the low resource electrodes and the associated high probability of failure of ignition sparks between these electrodes. Due to the high electrical resistance of oil, the distance between the electrodes is required to be very small. For example, the distance may be on the order of about 1 mm. However, the inter-electrode distance increases rapidly due to electrode erosion, leading to termination and/or breakdown of the system. Furthermore, the use of such small gaps between the electrodes allows processing of only a very small sample size at any given time.

U.S. Pat. No. 5,626,726 describes a method of oil cracking, which uses a heterogeneous mixture of liquid hydrocarbon materials with different gases, such as the treatment of arc discharge plasma. This method has the same disadvantages associated with the small discharge gap described above and requires a special apparatus for mixing the gas with the liquid, as well as the resulting heterogeneous suspension. Heating of the mixture by a continuous arc discharge leads to considerable loss of energy, increased soot formation, and low efficiency.

Russian Patent No. 2452763 describes a method in which a spark discharge is carried out in water, and the impact from the discharge is transferred to a heterogeneous mixture of a gas and a liquid hydrocarbon or oil through a membrane. This increases the electrode discharge gap which increases electrode life but reduces the effectiveness of the impact of the spark discharge on the hydrocarbon or oil. This is because much of the direct contact of the plasma discharge with the hydrocarbon medium is excluded. Additionally, the already complicated construction using a high voltage pulse generator is further complicated by the use of a heterogeneous mixture preparation apparatus and device for separation of the treated medium from the water in which the spark discharge was created.

U.S. Patent Publication No. 2010/0108492, and U.S. Pat. No. 7,931,785 describe methods having a high conversion efficiency of heavy oil to light hydrocarbon fractions. In these methods, the heterogeneous oil-gas medium is exposed to an electron beam and a non-self-maintained electric discharge. However, the practical use of the proposed method is challenging because, in addition to the complicated heterogeneous mixture preparation system, an electron accelerator with a device output electron beam of the accelerator vacuum chamber in a gas-liquid high-pressure mixture, is required. The electron accelerator is a complex technical device which significantly increases both capital costs and operating costs. In addition, any use of the fast electron beam is accompanied by a bremsstrahlung X-ray. As such, the entire device requires appropriate biological protections, further adding to the cost.

Plasma chemical reactors can be added as refinery upgrading technologies for all feedstocks. Implementation of such reactors in the refinery process rather than a heavy oil field process offers a simple and incremental development plan relative to field implementation. This is mainly because the oil to be passed through these reactors in the refineries will already have gone through many pre-processing such as dewatering, desalting, and atmospheric distillation. Hence, the overall processing will be significantly simpler compared to field implementation. The refinery can supply line voltage power, and carrier gases readily without additional requirements to include these in the upgrading process. Furthermore, these reactors will not have to meet the stringent pipeline requirements for viscosity, density, olefin content and oil stability needed in the field.

From the refinery's perspective, there will be an increased production of desired distillates and decreased loading on the coker and hydrocracker, thus by debottlenecking the process chain.

### SUMMARY

In one aspect, provided is a single spark gap scale-up method for a plasma chemical reactor for processing hydrocarbons. The method may comprise defining a set of parameters including at least one of performance indication parameters and scale indication parameters, wherein performance parameters indicate the plasma-gas and plasma-liquid interaction in the multiphase reactor, and wherein scale parameters represent the reactor space utilization efficiency and overall size. A single gap scale up model may be developed to enhance scale parameters. A parametric study may be conducted to estimate a number of spark gaps and total mass information for the spark gaps.

In another aspect, provided is a method for multiple spark gap scale-up with reactor modules of a plasma chemical reactor for processing hydrocarbons. The method may comprise using a plurality of reactor modules to build a three-dimensional reactor matrix. A resulting device may include a number of electrical discharge modules selected based on a production requirement.

In some implementations, the method further includes using the resulting device to process hydrocarbons in an oilfield or refinery.

In some implementations, the discharge modules can be assembled without onsite construction.

In some implementations, the discharge modules are skid or portable.

In some implementations, the resulting device is used independently as an oil treatment reactor or used within an oil treatment system after incorporation in the oil treatment system.

In some implementations, the method further comprises arranging discharge modules in a reactor matrix such that a selected column or row may be turned off without turning off remaining columns or rows, respectively.

In some implementations, the method further includes connecting the reactor matrix to external fluid and electrical devices via quick connects.

In some implementations, each discharge module transmits sensor data to a server in real time to allow for remote diagnostics and monitoring.

In some implementations, gas and flow control to each discharge module is separated from other discharge modules.

In some implementations, the method further includes adding or removing a discharge module with reduced gas leak or disturbance.

In some implementations, liquid level may be controlled in a discharge module in a passive way.

In some implementations, the method further includes running the reactor continuously with various stages or steps of the process occurring simultaneously or sequentially, such that the liquid hydrocarbon material is continuously fed to the discharge reactor as the product hydrocarbons fractions are exited from the reactor.

In some implementations, the product hydrocarbons include light fractions to be separated from distillation and solids that are produced in the discharge gap but need to be removed from the product.

In another aspect, a three-dimensional reactor matrix for processing hydrocarbons in an oilfield or refinery is provided. The reactor matrix may comprise at least three electrical discharge modules arranged in a matrix such that a column or row of discharge modules in the matrix may be selectively turned off without turning off discharge modules not in the selected column or row.

In some implementations, the reactor matrix is configured to transmit real time information about discharge modules to a server for online diagnostics and monitoring.

In some implementations, the reactor matrix can be composed of various different reactor modules such as a combination of 4 spark gap reactor module, 8 spark gap reactor module, welded vessel metal reactor module or foam reactor module.

### BRIEF DESCRIPTION OF THE DRAWINGS

FIG. 1 illustrates example multiphase reactor scale up process pathways.

FIGS. 2A, 2B, and 2C provide example schematics of bubble behavior in liquids between electrodes of a spark discharge circuit.

FIG. 3 illustrates methane bubbling into mineral oil without application of voltage to a spark discharge circuit.

FIGS. 4A, 4B, and 4C illustrate different bubble breakdown mechanism in liquids.

FIG. 5 illustrates an example Oil Treatment Reactor (“OTR”) with one spark gap (“OTR1”) parametric design with varied device length (L), according to an illustrative embodiment.

FIG. 6 illustrates an example OTR1 parametric design with varied oil chamber diameter (D), according to an illustrative embodiment.

FIGS. 7A-7C illustrate an example cannulated reactor module unit with four spark gaps without a condenser, according to an illustrative embodiment. Included are the cross section (FIG. 7A), isometric (FIG. 7B) and side (FIG. 7C) views.

FIG. 8 is a photograph of an example M=4 module according to an illustrative embodiment.

FIG. 9 is a photograph of an example M=8 module according to an illustrative embodiment.

FIG. 10 is an illustrative M=8 module with integral high voltage power supply submodule according to an illustrative embodiment.

FIG. 11 illustrates an example reactor module unit with eight spark gaps and a condenser built in according to an illustrative embodiment.

FIGS. 12A and 12B illustrate an example M=7 welded vessel design made of stainless steel to work at high temperatures, with side (FIG. 12A) and isometric (FIG. 12B) views, according to an illustrative embodiment.

FIG. 13 shows an actual fabricated welded vessel OTR built in according to an illustrative embodiment.

FIG. 14 illustrates a sliding mechanism using layer of struts and wheels to slide in and out the rack of OTRs from the matrix according to an illustrative embodiment.

FIG. 15 illustrates a sliding mechanism using telescoping slides to slide in and out the rack of OTRs from the matrix according to an illustrative embodiment.

FIG. 16 illustrates a rack of OTRs configured with sliding mechanism, distributor manifold, sliding handle and other necessary accessories, according to an illustrative embodiment.

FIG. 17 illustrates a rack of OTRs that can be increased to N numbers, according to an illustrative embodiment.

FIG. 18 illustrates an array of OTRs that can be increased to N×N numbers, according to an illustrative embodiment.

FIG. 19 illustrates a matrix of OTRs that can be increased to N×N×N numbers, according to an illustrative embodiment.

FIG. 20A illustrates top view of the matrix of OTRs connected to feed and storage tanks using piping system with manifold feeding to and out of all the OTRs, according to an illustrative embodiment.

FIG. 20B illustrates side view of the matrix of OTRs connected to feed and storage tanks using piping system with manifold feeding to and out of all the OTRs, according to an illustrative embodiment.

FIG. 21 illustrates an isometric view with labelling of the matrix of OTRs connected to feed and storage tanks using piping system with manifold feeding to and out of all the OTRs, according to an illustrative embodiment.

FIG. 22 illustrates an electrical manifold that can be connected in orientation with a rack for supply of high voltage to OTR, according to an illustrative embodiment.

FIG. 23 is a photograph of the gas manifold and the gas system integrated with the matrix of OTRs, according to an illustrative embodiment.

FIGS. 24A and 24B illustrate an HV insulator, showing isometric (FIG. 24A) and top (FIG. 24B) views, according to an illustrative embodiment.

FIG. 25 is a photograph of a small pilot scale matrix, according to an illustrative embodiment.

### DETAILED DESCRIPTION

The present technology relates to the field of processing liquids containing heavy hydrocarbon molecules into the lighter liquid and/or gaseous fractions. The present technology can be utilized for the cracking of liquid heavy oils to lighter hydrocarbon fractions by using a stream of carrier gas injected into the liquid heavy oil to form a mixture, followed by ionization of the mixture by electric discharge. This technology can be effectively applied to achieve efficient heavy oil conversion.

In one aspect, a process is provided for cracking liquid hydrocarbon materials into light hydrocarbon fractions by using a spark discharge. The process includes flowing a liquid hydrocarbon material through a discharge chamber and into an inter-electrode gap within the discharge chamber, where the inter-electrode gap is formed between a pair of electrodes spaced apart from one another. The process further includes injecting a carrier gas into the liquid hydrocarbon material as it enters the inter-electrode gap, thereby forming a gas-liquid hydrocarbon mixture. The pair of electrodes includes a positive electrode and a negative electrode, the negative electrode being connected to a capacitor. The capacitor is charged to a voltage equal to, or greater than the breakdown voltage of the carrier gas in the inter-electrode discharge gap. As the gas-liquid hydrocarbon mixture is formed, it is subjected to a current between the electrodes at a voltage sufficient to cause a spark discharge. The process also includes recovering the light hydrocarbon fractions resulting from the impact of the pulsed spark discharge on the gas-liquid hydrocarbon mixture.

There are several challenges to scaling up of reactors. A goal of scaling up is to design a pilot or industrial reactor able to replicate, through a standard methodology, the results obtainable in the laboratory. One limitation is there is no standard way through the process which can help avoid problems and reduce business risks. One reason for a lack of a standard approach is that kinetic data are so peculiar to the system being tested, and the data are normally confounded with mass transfer and fluid dynamics. Independently studying the intrinsic kinetics and transport phenomenon is difficult. Also, there remain gaps between industrial scale technologies and equipment and those used in the laboratory. Moreover, transport processes such as mass, heat, and momentum transfer are scale-dependent, implying different behaviors between laboratory models and full-scale plants.

Due to the scaling up complexity mentioned above, various possible problems may be encountered. For example, there is a potential loss of control if the reaction is exothermic, because the change in heat transfer area per unit volume varies with scale. This problem is less pronounced or non-existent for slow and endothermic reactions. Also, conversion and selectivity are negatively affected by the scaling-up owing to differences in mass transfer across phases. Moreover, different extraction and separation methods are involved at different scales, since reactions in a larger scale plant even at the same conversion will produce significantly more products, and they will accumulate in the system before being removed. Further, issues arise with respect to compatibility with glass, stainless steel and other materials. Laboratory reactors are often made of glass, while in industry, engineers often prefer stainless steel or metallic equipment in the plant. Corrosion and undesired reactions might take place if processing materials are not compatible with the selected reactor material. Similarly, electrode materials are also important, since they not only affect the discharge behavior but they also might change the properties of the processed liquid.

Scaling up a chemical reactor involves quantitative rules that describe the operation of the reactor at different scales, operation conditions, and with different reaction technologies. Relevant parameters may be investigated in laboratory experiments, including discharge characteristics (e.g., capacitance, discharge pressure and gap, energy per pulse, circuit configuration), flow conditions (e.g., gas flow rate, superficial gas velocity, gas holdup, gas bubble size, liquid density, viscosity and surface tension), and the number of spark gaps. Since the number of parameters is large, it is advantageous to design an experiment such that effects originated from different parameters could be independently studied on the behavior of this plasma chemical reactor.

In general, laboratory measurements on a gas-liquid reactor are taken to investigate mechanisms independent of the size, such as reaction kinetics and thermodynamics. Physical properties like density, viscosity, surface tension, specific heat, bubble size and surface area should be known as operating conditions. Their effects on the chemical reaction, namely conversion and selectivity, should be investigated. In addition, plasma behavior changes due to parameters like capacitance, gas flow conditions, and bubble behaviors should also be studied. Special attention should be given to: (1) the interactions between gas bubbles and liquids; (2) the interactions between plasma volume and total gas volume; and (3) where breakdown happens, which are primarily determined by the gas-liquid property (bubble size, bubble number density as well as the liquid property) and discharge characteristics. Parameters might be defined to indicate the interaction, for example, interphase contact area: area of bubbles over volume of liquid and discharge volume over total gas volume. One of the goals for gas-liquid reactor is to maximize these values. This plasma chemical reactor used for hydrocarbon cracking is characterized by slow reaction rate, low conversion, and high non-equilibrium chemical reaction. As a consequence, bulk fluids heat transfer, mass transfer, and thermodynamics will probably not change significantly after scale up, which means the quality of the scaling up process mainly depends on how well the gas-liquid contact and plasma-gas contact are optimized.

Process analysis and economics may also be evaluated even at a very early stage. Because the experimental domain of interest might shift due to process safety and economics, such evaluation potentially helps improve the quality and progress of work by helping avoid excessive research efforts in directions that are of less interest or that are otherwise lower priority.

A pilot plant is often built after the technology and device are extensively investigated in the laboratory before scaling up to a full-scale plant. The pilot plant is not only intended to prove the existing lab unit yields the same results on a larger scale, it also tests the technology and device used on an industrial scale. Further, the pilot plant allows evaluation of product specifications and setup automation and control system for industrial use which are not commonly seen in the laboratory. Example embodiments disclosed here provide scale up processes with flexibility. A pilot plant may be built by using many discharge modules. The number of discharge modules may depend on the product rate and other process requirements.

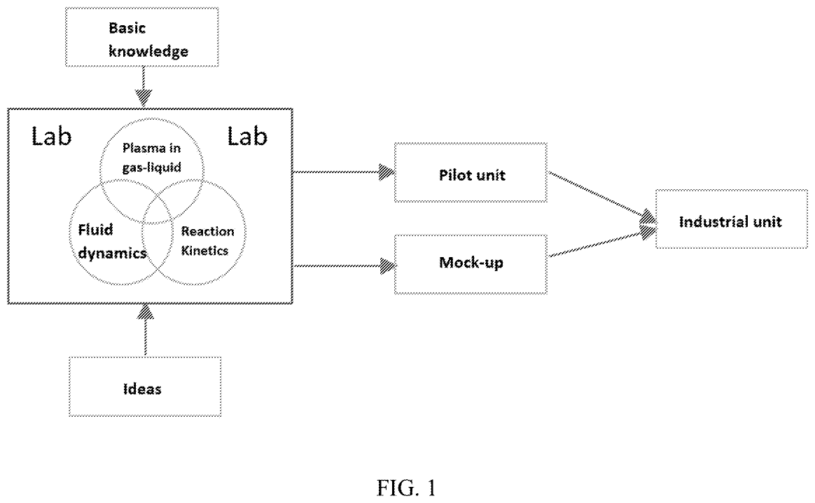

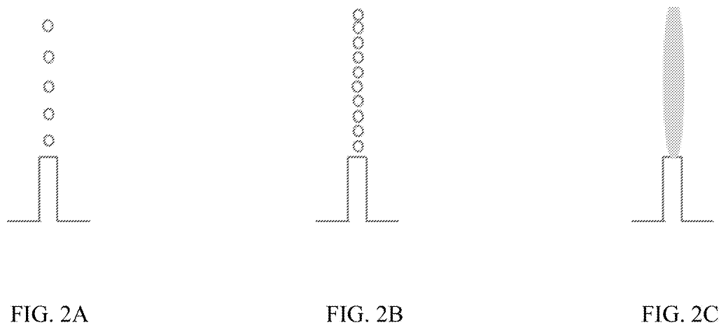

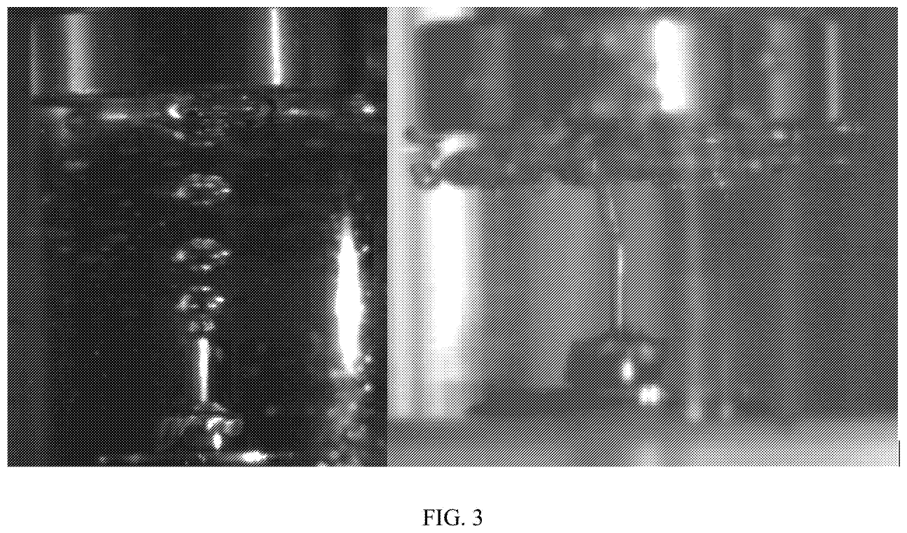

For the purposes of this discussion on scaling, the minimum unit is a plasma reaction zone which is defined by a single discharge gap and gas bubbles within a liquid within that gap. A reactor module consists of multiple plasma reaction zones, N, arranged within a single vessel that isolated the processed media from the ambient environment and has liquid, gas, and electrical inputs and outputs. These plasma reaction zones may be arranged in a linear array as shown in FIG. 1 or 2D matrix within the module. The modules are placed side by side into a one-dimensional horizontal array, with M modules, called a module rack. These module racks can be arranged vertically into a module array of P racks. Multiple module arrays can be combined into a three-dimensional module matrix, of Q arrays. Matrices of modules may be combined with ancillary equipment to define a processing unit which has N*M*P*Q plasma reaction zones. Multiple processing units may be combined with or without additional ancillary equipment to increase overall system throughput.

At a large scale, parameters like heat transfer and flow distribution will be different and size dependent. Consequently, when scaling up the reactor, it is important to know that the reactor still possess the same behavior in terms of conversion and product specifications. Often the reactor behavior will change with respect to its size as a result of the reasons mentioned above. It is noted that it is not always necessary to build a pilot plant in order to evaluate technologies and devices. Less costly and more convenient mock-up experiments may model a large-scale plant and help in evaluating full-scale plants, especially when size-dependent parameters are not dominating in the process. There are other reasons that people do not build a pilot plant, such as the high costs. But information regarding the reaction and reactor obtained at a scale closer to the full size tends to be more like what will happen in its industrial size reactor.

When the pilot plant has been demonstrated to be feasible and economically viable, a full-scale unit may be built. A full-scale plant may be a three dimensional matrix composed of discharge units suited to the full scale production rate. The same method could be followed by carefully increasing the number of modules in different dimensions. A full-scale plant should behave in a very similar way as the pilot plant except that its production rate, energy consumption, and cost is expected to be higher depending on the number of modules. It is noted that costs above the pilot plant might not increase linearly as the number of modules increases.

FIG. 1 represents key elements that are involved in example scale-up processes. Once enough knowledge has been developed and accumulated in the laboratory on the reactor technology and device, the knowledge may be combined to build a mathematic model. This model should include all aspects that play important roles in the process, such as fluid dynamics, plasma in gas-liquid, reaction kinetics as well as thermodynamics. These aspects are highly coupled with each other and inter-dependent, contributing to the complexity inherent in scaling-up of reactors. Certain parameters in the model are size dependent while others are not. It is important to recognize and consider both. The parameters obtained or derived from the laboratory may change significantly with reactor size. Running the mathematic model may thus require additional tools, such as programming/coding. In the model, the physical size, number of discharge gaps, and/or the fluid flow rates can be changed to scale up the reactor. Then, the resulting size of the reactor, the number of reactor units, as well as the production rate will be calculated.

One illustrative method disclosed herein is applied to a single spark gap. A series of parameters are defined as performance indication parameters and/or as scale indication parameters. Performance parameters indicate the plasma-gas and plasma-liquid interaction in the multiphase reactor. Scale parameters represent the reactor space utilization efficiency and overall size. Another example method disclosed herein is applied to scaling up an Oil Treatment Reactor (OTR) that could process oil at a much higher production rate. This example method uses multiple discharge modules to build a three-dimensional reactor matrix. The resulting device with varied number of electrical discharge modules to process hydrocarbons could be used in the oilfield or refinery. Modules could be easily assembled to work either independently as an oil treatment reactor or work within existing system after incorporation. The number of modules can be readily varied according to production needs. Troubleshooting and replacement of such modules are easier since each may be independent from others.

Compared to other types of oil treatment reactors, the disclosed example devices have multiple distinct advantages. For example, the number of modules and discharge units could vary flexibly depending on the production and other requirements. Consequently, the device is compatible with production rates that might vary by more than one order of magnitude. Device maintenance and part replacement is easier and more cost effective because the device is configured to run in a manner that is analogous to supercomputer servers, such that adding and removing of modules are virtually instantaneous tasks. Illustrative devices disclosed herein are compact and capable of having a very robust structure. In some implementations, the devices could serve as mobile oil treatment reactors and be transported to wherever they are needed, such as near the oilfield or in the refinery. The heavy oil cracking devices with many electrical discharge modules are applicable to process crude oils and other refinery intermediates as well as other hydrocarbons. Different scaling parameters may be defined to comprehensively characterize a single spark gap discharge process as well as the scaled-up multiple modules reactor performance and its physical size utilization efficiency.

In example embodiments of the present disclosure, a methodology for scaling up a multiphase plasma chemical reactor using gas bubbles discharge in liquids to process liquid hydrocarbons is disclosed. Some implementations are applied to a single spark gap discharge scale up process and its characteristic parameters. A series of parameters may be defined as the performance indication parameters or scale indication parameters to characterize a single spark gap. Performance parameters may be identified to indicate the plasma-gas and plasma-liquid interaction in the multiphase reactor. Scale parameters may be identified to represent the reactor space utilization efficiency and overall size.

Other implementations are applied to multiple spark gap reactors with multiple discharge modules and its dimension information. In such implementations, multiple discharge modules may be used to build a two or three dimension reactor matrix. For example, such an approach can be used either in the oilfield or refinery as a mobile and extensible plasma chemical reactor. The size and capabilities of such devices may be controlled adaptively to match production requirements.

The principles and operation of example modular spark gap discharge reactors disclosed herein are, advantageously, user-friendly, and may be better understood with reference to the drawings and the accompanying descriptions.

The resulting device, in various implementations, allows a varied number of electrical discharge modules to process hydrocarbons. The device may work either independently as an oil treatment reactor or may be incorporated to work within an existing system. Due to its fractal modularity nature with portable units, its processing capability may grow incrementally as needs change. The required number of modules and matrix configuration may be determined or selected based on, for example, the required production rate and specific energy input.

Example modules may be arranged in a matrix that allows users to selectively turn off a column or a row. In some implementations, a three-dimensional (3D) matrix with series discharge units may operate at different optimized reactor conditions. In other implementations, a two-dimensional (2D) matrix may allow a very high throughput. A reactor matrix may be connected to external fluid and electrical devices via quick connects. Connections between modules may allow hot swapping, such that module changes will not cause system shutdown. Hot swapping refers to the capability of performing maintenance on an individual module or group of modules within the 3D matrix of modules without shutting down the entire system. This can be done because many of the modules operate in parallel off a manifold. The manifold may have quick connects that can connect with subset of module group and individual modules. When connecting or disconnecting a module, only local disconnection is required without affecting the entire system.

Maintenance and part replacement of modules may be easy since each may be independent from others. Diagnostics and monitoring may be performed for each module and each spark gap within the module. This may be accomplished by having each module transit sensor data to a remote server. Modules may provide high voltage circuit connections and insulation, which may be attached to the bottom of modules in compartments for better insulation. Circuit elements may be incorporated. The circuit for each module can thus be wholly or partially independent from the other circuits. For example, the circuit associated with each gap may convert line voltage to the high-voltage pulsed DC for that gap, or the circuit associated with each gap may convert moderate or high voltage AC to high voltage pulsed DC for that gap with a common circuit element converting lines voltage to the moderate or high voltage AC. Each module may have its own diagnostic and monitoring device online. When failure happens, the failed module could be identified and shut down for maintenance or replacement. For example, in a 10×10×10 matrix of modules with each module containing 10 individual processing gaps, an individual module failure is on the order of 1/1000th of the total system operation and has very limited impact on the system. Similarly, one gap may be 1/10000th of the entire system.

In various implementations, safety may be enhanced via an online diagnostics and monitoring system capable of providing real time information about each module as well as the device as a whole. When faults happen, it is possible to selectively shut down modules or the device. Gas control and flow to each module may be separated from others. When modules are removed or added, gas leak or disturbance caused by the adding or removing process may be minimized. This is done through independent valving of gas and liquid flow to each module and/or through quick connect type fittings (pipe and tubing fittings which when separate have a shut off/sealing feature) which maintains the closed systems integrity. This type of connector can be applied to all various gas, liquid, electrical connections. Mechanical connections and supports for the module may also be latching type connections designed for rapid interchangeability of the modules. Each module effectively works independently with its own flow control and circuit control.

Due to changes in hydrostatic pressure, it is generally a challenge to have an array of modules and have the same liquid level in all of the modules. In some implementations, liquid level may be controlled within the module in a passive way. One example of this is using a weir, sluice, or sluice/weir-type combination device at the exit of the module to control the liquid level. Another example is using an orifice constriction on the module inlet such that the orifice pressure drop is more significant than the hydrostatic pressure drop and pressures to the modules would be relatively constant. A combination of these methods may be employed in part or together so that liquid level height will not depend on the pressure drop (friction, flow and/or hydrostatic) in the line.

As the reactor is to be run continuously in various implementations, the various stages or steps of the process may occur simultaneously or sequentially, such that the liquid hydrocarbon material is continuously fed to the discharge reactor as the product hydrocarbons fractions are exited from the reactor. Product hydrocarbons may include light fractions that need to be separated from distillation and solids that are produced in the discharge gap but need to be removed from the product.

As used herein, the term “module” refers to an independent and portable unit that comprises several discrete discharge reactor units. Each reactor unit may include multiple spark gaps that could also work either independently or in a group that shares the same carrier gas and electrical circuit control. Such modular design requires no onsite construction. No parts of this device or ancillary components necessary for this device to run needs to be built onsite because, for example, this device is composed of modules and each module may be skid mounted or portable. Overall size of a group of modules which comprised a discharge reactor may be selectively chosen to facilitate delivery of the skid(s) by standard commercial transportation appropriate for the site. A goal of such a design may be to allow it to be used in different locations, for example on the oilfield, offshore, or in the refinery. The only installation required may be to plug in electrics, gas feeds as well as input and output feeds. When delivered to a site electrical, gas, liquid feeds, and products will need to be connected. These may be done with standardized piping, hosing and electrical connections appropriate to the site/application. The modules would not require onsite-construction including welding, structural assembly, concrete slabs or other work typically completed in refinery construction. Similarly, spill containment systems, gas detection safety systems, fire suppression systems, and similar ancillary systems could be integrated into the module and would not need be installed after delivery. Multiple skids each containing multiple modules could be used to meet any desired throughput or volume processed.

Prior attempts at modularity have been significantly different. For example, significant onsite construction and assembly of large components was required. Furthermore, the minimum processing unit was significantly larger. By contrast, in example implementations, the minimum processing unit may be a single discharge gap which can be designed to process from 0.01 to about 0.1 bbl/day. For example, through a large plurality of these skid comprising 10's, 100's, 1000's, or 10,000's individual discharge gaps and processing ranges from 0.01 bbl/day to 1 kbbl/day can be achieved.

The term “scalable” as used herein indicates that the number of modules is extensible without the need for extra equipment. For example, with a multiplicity of modules a single pump, heating, or condensation can be used and additional module may not require the addition of additional extra equipment to the system.

The term “heavy oils” as used herein refers to those hydrocarbon mixtures which are in liquid state at atmospheric conditions. Heavy oils based on a technical definition have density and viscosity above certain values and typically have lower market price compared to light oils. Heavy crude oils and atmospheric residues are two examples that may be well-suited to the definition. The hydrocarbons may include, but are not limited to, paraffins, aromatics, naphthenes, cycloalkanes, alkenes, dienes, and alkynes. They may be characterized by the total number of carbon atoms and the amount of single (C—C), double (C═C) or triple (C≡C) bonds between carbon atoms. It may be used for readily generating light fractions, such as gasoline and kerosene or heavier fractions such as diesel oil and fuel oil. The hundreds of different hydrocarbon molecules in crude oil are converted, using the reactor and process of the present technology, into components which can be used a fuel, lubricants and as feedstocks in other petrochemical processes.

In example single spark gap scale-up implementations, it is important to understand how a single spark gap discharge works as a plasma chemical reactor, including discharge characteristics and relevant reactions, to identify parameters that affect the results of interest. The disclosed approach may include finding parameters and processes that change with size and those that are relatively independent of reactor size. A model may be developed to assist with the definition and study of parameters.

In example implementations, scale up parameters may be derived. The scale-up parameters may be independent of the reactor size and allow direct comparison of modeling results from different scales. A first parameter is defined as the ratio of gas discharge volume to the total gas bubble volume in the gap: r₁=discharge volume/bubble volume. This value roughly indicates the gas utilization efficiency and has a possible range of 0 to 1. The ideal range for this parameter may be, in various implementations, 0.5 to 0.9. However, value ranges of 0.1 to 0.99 may still provide very good processing conditions. Values of r1 as low as 10\hat{ }−3 may also produce acceptable conversions in the chemical reactions. Gas discharges over liquid surfaces may have effectively r1<10\hat{ }−3 and are generally less efficient in the chemical conversion. Such a parameter range maximizes the interaction of reactive gas species from the discharge with liquid hydrocarbon molecules on the bubble liquid interface. Too high a value of this parameter may be undesirable as such values will inherently lead to constant volume heating processes pathways and too high pressures and temperatures during the electrical discharge process and thus unfavorable process kinetics. Too low a value will result in significant generation of reactive species in the gas phase which react only with other gas phase molecules and do not interact with the liquid phase molecules. This first parameter depends on the discharge characteristics in gas-liquid two phase fluids.

A second parameter defined is the ratio of gas phase volume to the total fluids volume as r₂=gas phase volume/total two phase volume in the gap. The value for the second parameter is equal to the gas holdup ratio in the gap within the range. Possible values for this are 0 to 1. Too high a value indicates lots of gas bubbles within the discharge gap. Too low a value results in breakdown in the liquid phase rather than the gas phase, this corresponds to a ratio r₁=1, which is undesirable. A related and equally important parameter is the ratio of the plasma discharge surface area to the oil surface area which is r₁\hat{ }(2/3). Similarly, related is the plasma interaction depth, tₚ, perpendicular to this surface and the liquid interaction depth, t₁, perpendicular to this surface. The related parameter is thus r1′=r1\hat{ }(2/3)*tₚ/t₁ and generally scales with r1 although variations in the gas phase pressure and liquid number density can cause discrepancies between r1 and r1′. R1 is important both for the quality of the conversion of the oil and the overall size of the system. R1 can be controlled by bubble size, bubble position, bubble to bubble spacing, electrode size, electrode shape, electrodes position, bubble pressure, liquid properties, discharge energy, discharge voltage, gas properties, and other reactor operating parameters.

The difference between the first and second ratios is that r1 only represents the local gas hold in the discharge region, while r2 is the gas holdup in the entire oil chamber. This is because two-phase reactions only happen at the interface between gas and liquids. R2 is of more significance for the overall scaling and sizing of the system. Also, r2 relates to the overall mass utilization efficiency and necessity for gas recycling in the system.

In an efficiently scalable oil treatment reactor it is important to control r2. R2 is affected by various fluid, gas and flow parameters. The average gas bubble diameter and gas holdup primarily depends on the liquid properties and gas superficial velocity and liquid depth r₂=f(ρ,σ,μ,θ,h), where ρ, μ, σ are the liquid density, viscosity and surface tension, respectively, while θ and h are the gas superficial velocity and liquid height in the gap, respectively. For example, higher viscosity can reduce the holdup but increases the average size of the bubbles and higher superficial gas velocity increases the holdup but decreases the bubble size. This indicates a nonlinear effect of superficial velocity on r₂. Fluid property control, as well as flow modeling and experimental parameter selection can be used to attain an appropriate r2.

A third parameter defined is the ratio of fluids volume in the unit to the total unit volume as r₃=fluids volume/unit volume. This value highly depends on the oil chamber length to diameter ratio length/diameter and the configuration of the OTR unit (e.g., how to organize its electrical parts (capacitor and resistor) as well as the liquids inlet and outlet). The third value (r₃) should have less effects on the plasma chemical process, because it is essentially a physical parameter of the reactor. But its effect on the overall reactor size and cost is significant because the difference caused by it could be as high as a factor of 5-10. Following the same idea of r₂, a fourth parameter r₃, is defined as the ratio of fluids volume to the unit square volume: r₄=fluids volume/unit square volume. It may be assumed the reactor unit looks like a rectangular solid the volume of which is simply L×H×W. A fifth parameter defined is r₅, or the ratio of gas bubble surface area to the total fluids volume: r₅=bubble surface area/total fluids volume. The value for the fifth parameter is significant because gas liquid reactions only happen at the interface and the value indicates how well the gas and liquid are contacting with each other.

A sixth parameter defined is the relative gas bubble column length in the gap: r₆=L_{bubbles}/d_{gap}. This parameter is important because it determines the gas discharge behavior and gas liquid contact, which are the two most important things for a plasma chemical reactor. If the gap is constant, L_{bubbles}+L_{liquids}=d_{gap}. This parameter depends on the two phase flow pattern.

FIG. 2 shows three different flow patterns from the left to the right: less dense bubbly flow, dense bubbly flow and annular flow. The estimated r₆ resulted from them are 0.25, 0.85, and 1, respectively. Flow pattern A happens at a very low superficial gas velocity and bubbles are well separated. Most of the gap was filled by liquid, so that the breakdown voltage would be very high, which is not desired. Flow pattern B occurs when the gas superficial velocity is high enough to have a large number of bubbles well distributed but still separated from each other. This can be desirable to attain appropriate values of r1, r1′, and r2. In this type of flow pattern there are a lot of bubbles in the spark gap and the liquid layer between bubbles are thin. In this case gas and liquid have large contact areas. Gas breakdown voltage is easily controllable and not too high (which results in too high a discharge energy and too high an r1). Flow pattern C is called annular flow. Annular flow basically happens at a very high superficial gas velocity and all the bubbles combine into a gas phase column that directly connects two electrodes. The disadvantage of pattern C is that it will not provide enough contact between post discharge reactive gas species and the liquids, even though the electrical breakdown voltage to generate the plasma might be lower. In condition C, r1 is too small. The desired flow pattern in this case is B, where both the gas discharge and gas liquid contact were optimized. In various implementations, parameter r₆ should be in the range 0.8<r₆<1.

FIG. 3 shows two different bubble behaviors in liquids when flowing methane into lighter mineral oil at 0.03 LPM (liters per minute) through a 0.5 mm needle. The major difference is when there is applied voltage, the electrical field will help reduce the size of the bubbles and increase their number. The electric field increased the gas superficial velocity significantly. It might change the flow pattern from bubbly flow to annular flow if the original gas flow rate was too high. The value of rₒ changes in this case from less than 0.5 to more than 0.95.

The seventh and eighth parameters can be defined as r [symbol] and r [symbol] . They are both dimensionless numbers independent of the size of the reactor. The results of oil residence time multiplied by discharge frequency is r₇=tₒᵢₗ*f while the results of gas residence time multiplied by discharge frequency is r₈=t_{gas}*f Parameter r₇ directly determines the energy deposition into oils and allows a two dimensional operation on the required dose: frequency change or oil flow rate change. Parameter r₈ indicates how many times a gas bubble participates in a discharge event prior to being convected from the reactive region of the reactor. Large values of r₈ are undesirable as the gas species in the bubble change with each discharge occurrence and high or uncontrolled values of r₈ lead to uncontrolled gas mixtures and less selectivity in the process products. Ideally the value of r₈ is in the range of 0.5 to 1. Values of r₈<1 are fine they just indicate a few bubbles pass through the reaction zone without having a discharge in them. Very low values of r₈ while not necessarily detrimental to the overall process conversion or economics are inefficient from a gas mass utilization point of view. Values of r₈>1 are undesirable from a gas mixture control and product selectivity point of view. Values of r₈<10 are probably within the acceptable range of process parameters. Gas phase species, for example, increasing this number will enhance the possibility of gas-involved reactions.

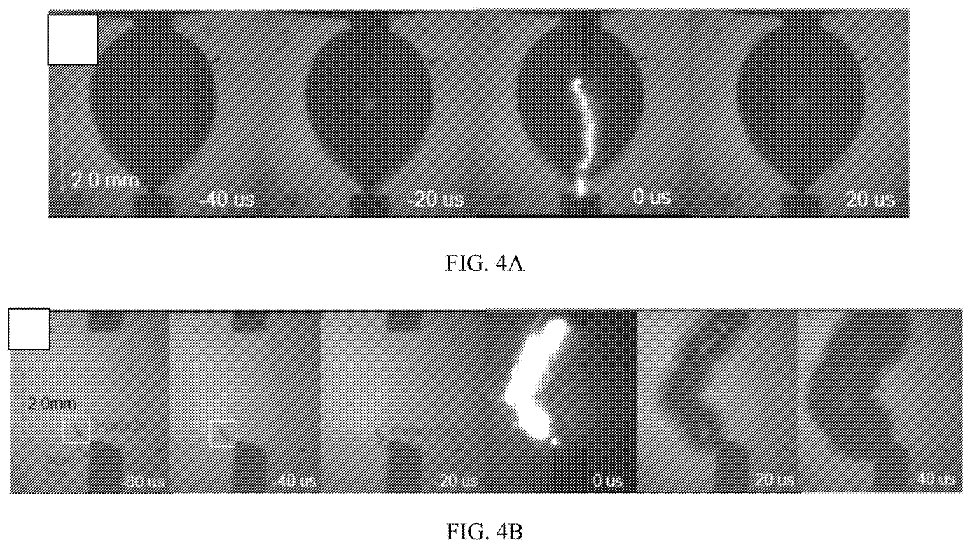

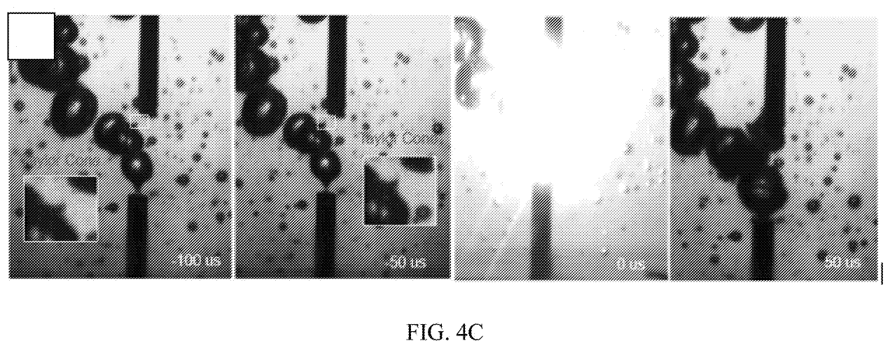

Another important parameter is the breakdown mode where discharge first happens. Ideally discharge occurs only in the gas phase because it requires less breakdown voltage (either in the bubble or on the bubble). It is also possible that breakdown first happens between the bubbles with a thin liquid layer. Multiple breakdown mechanisms have been identified in experiments to study this parameter. The first breakdown mechanism is believed to happen in the gas phase only when the entire spark gap was enclosed in a gas bubble, illustrated in FIG. 4A. Breakdown occurs first on the electrode tips where a stronger electric field is present. The second discharge mechanism, illustrated in FIG. 4B, is initiated by contaminants in the liquid. When contaminants get charged from one electrode and move in the electric field towards the second electrode, breakdown happens during this process. The third and fourth discharge mechanism, illustrated in FIG. 4C, may be due to charged bubbles. A Taylor cone on charged bubbles was observed. The subsequent breakdown was associated with the Taylor cone as it changes in the electric field between either two bubbles or bubble and electrode.

The eight scaling parameters defined above could be classified into two groups: performance indication parameters, including r₁, r₂, r₅, and r₆ which roughly indicate the gas liquid interaction in this plasma chemical reactor; and scale indication parameters, including r₃, r₄, r₇, and r₈, which might represent the reactor space utilization efficiency and reactor power intensity.

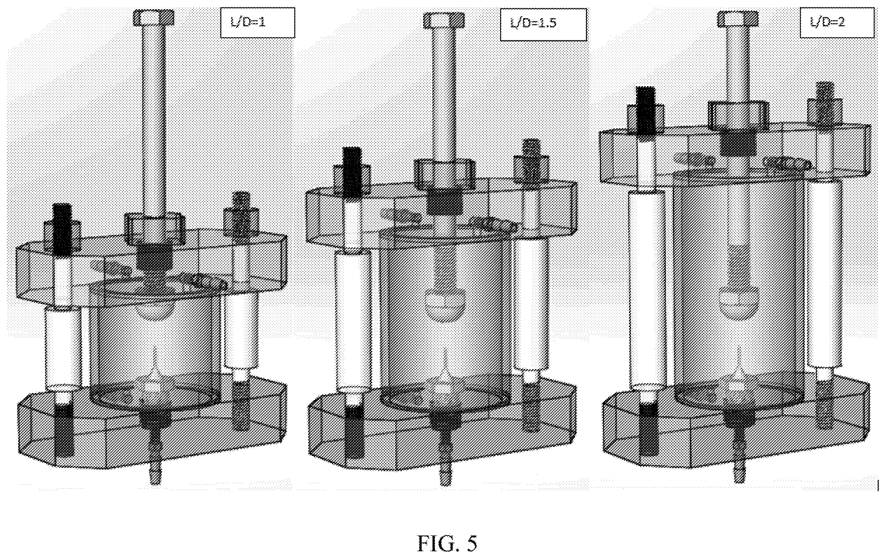

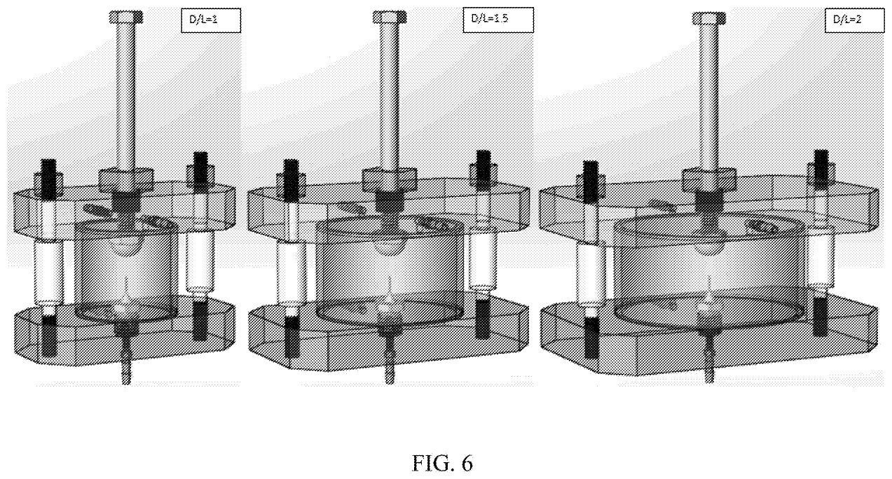

With respect to a single gap scaling model, in general, it is desirable to optimize or otherwise improve the scaling parameters defined above. The goal is to enhance the gas liquid contact without significantly increasing the overall size and weight of the reactor. Design and material selection for the reactor were also conducted in SolidWorks. To illustrate design and material selection for reactors, two 3D assembly models are shown in FIGS. 5 and 6. In FIG. 5, a constant oil chamber diameter with varied oil chamber height is illustrated, and in FIG. 6, a constant oil chamber height with a varied oil chamber diameter is illustrated. Default value for L/D is 1.23 (L=2 in (5.08 cm) and D=1.625 in (4.1275 cm)). The effects of these two designs on the scaling up parameters will be evaluated.

Based on two different design concepts with eight different configurations, the effects of reactor design and configuration on the reactor unit weight, volume and all the parameters defined above were estimated. A model was built in EES (Engineering Equation Solver). The default dose and production rate were chosen to be 200 kGy and 5000 bbl/day, respectively. In addition, it was assumed that the oil density is 900 kg/m³ and gas bubbles at 0.03 SLPM.

To better compare the effects of different designs, it was quantitatively assumed that r₁=1 for all the designs to represent the ideal case in which discharge happens in all the bubbles between two electrodes and r₂ is a portion of the gas holdup in the discharge region and depends on the oil property, the electrode distance and gas injections method. In the scaling model, it was assumed that average bubble diameter was equal to the gas injection needle inner diameter and number of bubbles in the gap was equal to the electrode distance divided by the bubble diameter. Gas bubble volume and gas bubble surface area were the results of the number of bubbles times the bubble average volume and average surface area, respectively. Based on the selected materials, reactor unit volume and mass were evaluated in SolidWorks. Overall number of unit and total weight and volume were estimated in the model.

Results for the single gap scaling model will now be provided. The OTR1 reactor configuration from different designs as well as all the scaling up parameters are summarized in Table 1. The discharge gap is 10 mm for all designs. Gas injection inner diameter is 0.25 mm and gas was injected into oil at 0.03 LPM. There is one gas injection needle as negative electrode and one plate on the top as positive electrode. The electric circuit includes a resistor and a capacitor which will not be displayed in the SolidWorks assembly. Both the L/D and D/L vary with values 1, 1.5 and 2.

TABLE 1
OTR1 design and configurations

| Plasma | Discharge | | | | | | Oil |
|---|---|---|---|---|---|---|---|
| Chemical | Gap | Needle | Electrodes | Capacitor | Resistor | Electrode | Chamber |
| Reactor | (mm) | Number | Pair | Number | Number | Material | Material |
| OTR1_varied L | 10 | 1 | 1 | 1 | 1 | Stainless | Acrylic |
| | | | | | | steel | |
| OTR1_varied D | 10 | 1 | 1 | 1 | 1 | Stainless | Acrylic |
| | | | | | | steel | |

Table 2 concludes the design and modeling results of the reactor with varied L/D and D/L values, including scaling parameters, reactor unit weight and volume, the number of reactor units as well as the total weight and volume in order to satisfy the production rate 5000 bbl/day. The effects of design on the reactor weight and volume can be readily ascertained by looking at r₃ and r₄.

Compared to design with L/D=1, the design with L/D=2 has an increased weight and volume by 12%, which means that the reactor physical size is sensitive to its L/D value. Even more important are the effects of the design on the reactor performance which can be characterized by parameters r₁, r₂, r₅ and r₆. It should be kept in mind that those parameters not only depend on the configurations of the reactor but predominately depend on the flow pattern of the two phase flow and applied voltage between two electrodes. For the provided flow condition and voltage, parameters like the bubble volume and bubble surface area should be similar. Since the oil volume in the chamber increased with increasing L/D value, r₂ and r₅ decreased accordingly.

The effects of D/L on the reactor weight and volume are more significant. The unit weight and volume increased by a factor of 2 if D/L changes from 1 to 2. It indicates that reactor physical size is very sensitive to its D/L value. A similar trend was found on r₁, r₂, r₅ and r₆ due to different design. They all decreased with increasing the D/L value. The difference, though, is that those parameters change more rapidly with changing D/L values.

TABLE 2
Design effects on all defined parameters and overall weight and volume

| | | | | | | | | | | | Total | Total | Number |
|---|---|---|---|---|---|---|---|---|---|---|---|---|---|
| | | | | | | | | | Unit | Unit | Mass | Volume | of Reactor |
| L/D (D = | | | | | r₅ | | | | Mass | Volume | (million | (million | Units |
| 1.625 in) | r₁ | r₂ | r₃ | r₄ | (1/m) | r₆ | r₇ | r₈ | (lbs.) | (in³) | lbs.) | in³) | (millions) |
| 1 | <1 | 0.000189 | 0.272 | 0.068 | 0.284 | | | | 0.670 | 12.384 | 13.71 | 253.2 | 20.45 |
| 1.23 (Default) | <1 | 0.000154 | 0.324 | 0.084 | 0.231 | | | | 0.689 | 12.779 | 14.08 | 261.3 | 20.45 |
| 1.5 | <1 | 0.000126 | 0.381 | 0.102 | 0.190 | | | | 0.710 | 13.254 | 14.52 | 271.0 | 20.45 |
| 2 | <1 | 0.0000948 | 0.477 | 0.136 | 0.142 | | | | 0.750 | 14.124 | 15.34 | 288.8 | 20.45 |
| | | | | | | | | | | | Total | Total | Number |
| | | | | | | | | | Unit | Unit | Mass | Volume | of Reactor |
| D/L (D = | | | | | r₅ | | | | Mass | Volume | (million | (million | Units |
| 1.625 in) | r₁ | r₂ | r₃ | r₄ | (1/m) | r₆ | r₇ | r₈ | (lbs.) | (in³) | lbs.) | in³) | (millions) |
| (Default) | <1 | 0.000154 | 0.324 | 0.084 | 0.231 | | | | 0.689 | 12.779 | 14.08 | 261.3 | 20.45 |
| 1 | <1 | 0.000189 | 0.272 | 0.0685 | 0.284 | | | | 0.671 | 12.402 | 13.72 | 253.6 | 20.45 |
| 1.5 | <1 | 0.000084 | 0.375 | 0.0912 | 0.126 | | | | 1.184 | 24.232 | 20.67 | 413.9 | 20.45 |
| 2 | <1 | 0.000047 | 0.453 | 0.108 | 0.071 | | | | 1.871 | 40.082 | 29.14 | 609.1 | 20.45 |

Example multiple spark gaps reactors with compact discharge modules will now be discussed. Single spark gap scale-up process is important because it determines the performance of this type of electrical discharge used in multiple phase reactors. If parameters are properly selected for one discharge gap its performance can be maximized. In various implementations, all other discharge gaps should be operating in the same way and with similar response. This paves the way for the next scale-up process using the second approach discussed here. The second approach uses multiple discharge modules to build a three-dimensional reactor matrix. The resulting device with varied number of electrical discharge modules to process hydrocarbons could be used in the oilfield or refinery. Modules could be easily assembled to work either independently as an oil treatment reactor or work within an existing system after incorporation therein. The number of modules can be varied relatively easily according to the production requirement. Troubleshooting and replacement of those modules is also easier since each is independent from others. This device is composed of modules. Each module can work independently with its own fluids flow control and power supply control plus the device and module may have manifold and quick connects that allow adding or removing modules without causing too much disturbance to the system.

In various implementations, this device with multiple discharge modules would be built into a continuous flow system of heavy oils so that heavy oils can be processed as it flows through the discharge chambers. This could be located near the production well on the oil field upstream of the transportation pipeline or in the refinery. Basically, it could work as a mobile oil treatment reactor and be transported to anywhere where it is needed. Upgraded oils will be transported or shipped if they meet the pipeline specifications. Gas mixtures could be made from co-produced gases and recycling gas from the reactor.

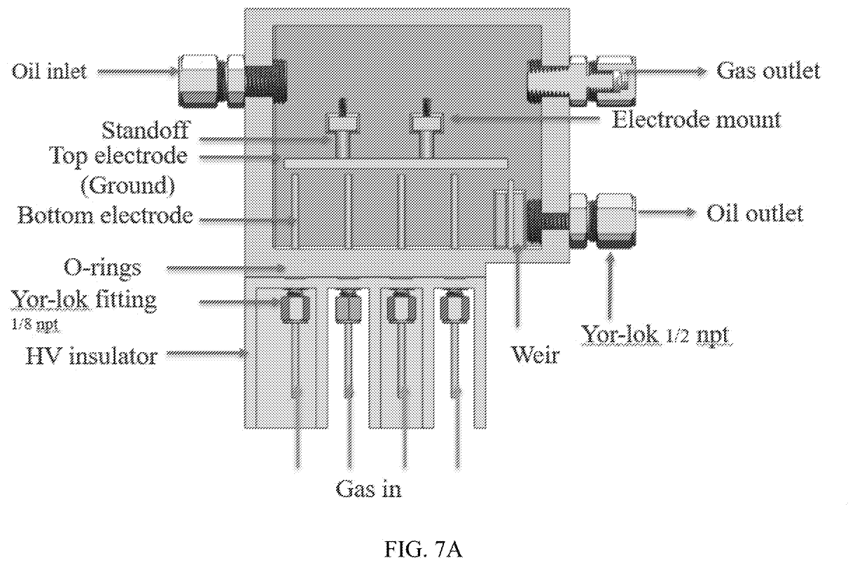

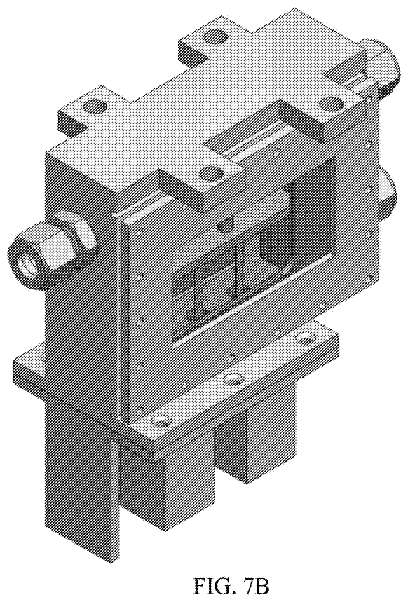

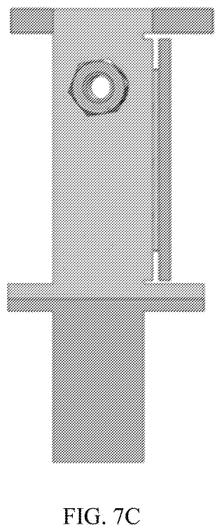

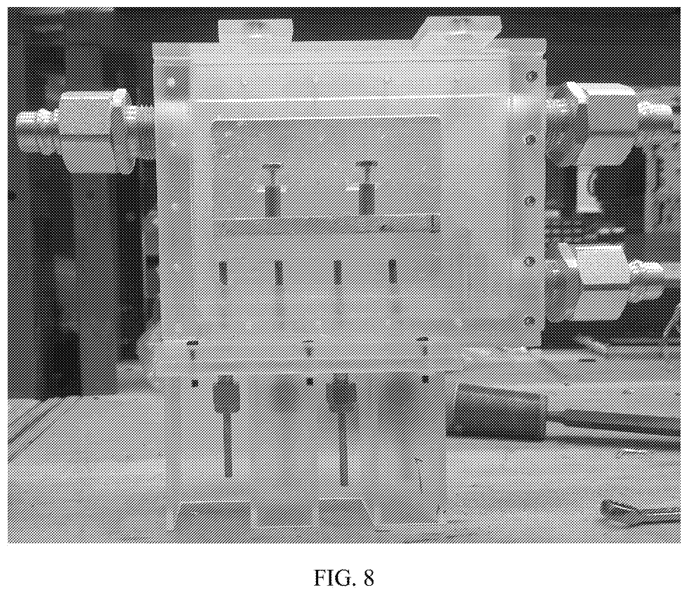

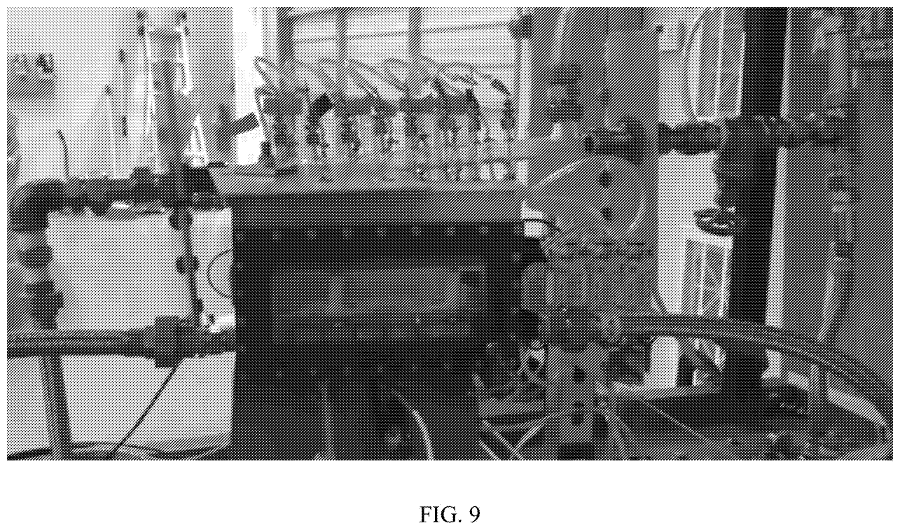

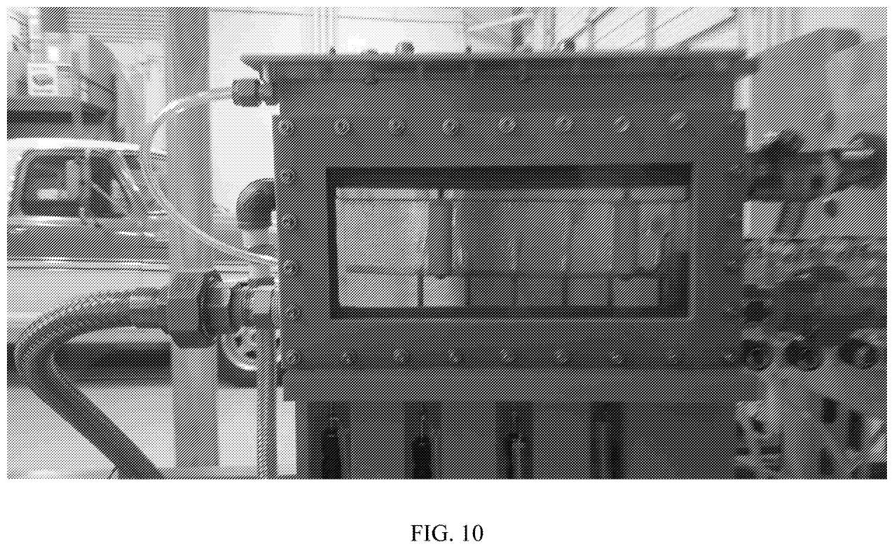

An example scale-up model with discharge modules will now be discussed. Three-dimensional multiple spark gaps reactor was designed in SolidWorks and 3D printed. They include both oil and gas feeding mechanism and multiple discharge gaps with electrode connection and insulation. FIG. 7 provides 3D views of one of the reactors with four spark gaps without a condenser. FIG. 8 provides 3D views of a similar reactor with a condenser. FIG. 9 represents a 1×3×3 matrix with 9 of the discharge reactor units. This could work as an independent discharge reactor module in certain implementations. Each module has its own gas inlet and outlet, feed input and output as well as electrodes and high voltage connections. Those features are designed to allow each module to run independently.

Results of reactor scale-up with modules will now be provided. After each discharge unit was fixed in design and size, a larger size reactor with many modules could be assembled. Each module could contain many discharge units with multiple gaps. The reactor production rate and power depend at least in part on the number of modules and how the discharge units are organized in the module. Advantageously, a module that could work independently and be compatible with other modules and the system could be designed such that, for example, it would be quick and easy to add or remove a module without affecting the system. The scaled-up device is composed of modules. Each module can work independently with its own fluids flow control and power supply control plus the device and module may have manifold and quick connects that allow adding or removing modules without causing too much disturbance to the system.

The power of the resulting reactor may depend on the required production rate and specific energy input to the treated oil. Then the total discharge gaps could be calculated from the total power and power of each spark gap. That may allow estimation of the number of spark gaps and modules needed to upgrade oils at a certain production rate with known specific energy input. The physical size of the resulting reactor may depend on the number of modules and the module configuration, which could be estimated based on the known information of each discharge unit. Table 3 estimates the number of spark gaps and modules with varying production rate 10-1000 barrel per day and assuming energy input is 200 kJ/kg. These values are based on mass balance and energy balance in a steady state open system. Specific energy input and mass flow rate are known based upon typical conditions for economic conversion of inputs to products, we can calculate the power of the system. Then divide the power by each spark gap power to calculate the number of spark gaps. With known spark gap number per module, we could calculate the number of modules.

TABLE 3
Number of spark gap and modules estimation based on production rate and specific energy input

| Energy | Production | Gap | Number | | | | | | | |
|---|---|---|---|---|---|---|---|---|---|---|
| input | Rate | per | of | Total | Number | Total | Total | Device | Device | Device |
| q | PR | Module | Modules | Power | of Gaps | Volume | Mass | Width | Length | Height |
| [kJ/kg] | [bbl/day] | GM | NM | P [W] | NG | V [in^{∧}3] | M [lbm] | D_w [ft] | D_l [ft] | D_h [ft] |
| 200 | 10 | 100 | 165.6 | 3312 | 1656 | 0.004192 | 1110 | 1.29 | 4.019 | 1.247 |
| 200 | 100 | 100 | 165.6 | 33122 | 16561 | 0.04192 | 11404 | 3.971 | 4.019 | 4.052 |
| 200 | 500 | 100 | 828.1 | 165612 | 82806 | 0.2096 | 58825 | 8.9 | 4.019 | 9.039 |
| 200 | 1000 | 100 | 1656 | 331224 | 165612 | 0.4192 | 124275 | 12.59 | 4.019 | 12.78 |

The benefits of disclosed example devices with multiple discharge modules include the following. Firstly, modules work as oil treatment reactor at atmospheric pressure and warm temperatures to upgrade heavy oils by converting heavy species to lighter ones. This less severe condition provides good process safety and saves significant capital cost used in extreme temperature and pressure situations. Secondly, each module works independently from others, therefore it is very cost effective and less time consuming during reactor maintenance and part replacement. And thirdly, this multiple module device could work potentially as a mobile oil treatment reactor because of the way it was designed. It is generally very compact and reliable and easy to transport.

In different versions, the disclosed approach uses varied number of discharge modules as oil treatment reactor to process heavy oils. Gas discharge was generated in oils and it reacts with oil molecules. Unlike lab-scale electrical discharge chamber used on hydrocarbon reforming or gas production, the disclosed approach uses multiple discharge units working together as an oil treatment reactor. In example implementations, a device uses many discharge modules and the number of modules could be varied based on the process and production requirement. Each discharge unit may use a methane and hydrogen mixture to generate a discharge in the oil and discharge characteristics may be tuned and controlled to match the oil processing requirement.

The following list of notations is relevant to this disclosure: OTR—Oil Treatment Reactor; r₁—Discharge Volume Over Bubble Volume; r₂—Gas Phase Volume Total Two Phase Volume; r₃—Fluids Volume Over Unit Volume; r₄—Fluids Volume Over Unit Square Volume; r₅—Bubble Surface Area Over Total Fluids Volume; r₆—Bubble Total Length Over Discharge Gap; r₇—Oil Processing Severity; r₈—Gas Processing Severity; L—Length of the Unit; H—Height of the Unit; W—Weight of the Unit; LPM—Liter per Minute; t_ₒᵢₗ—Oil Residence Time in Reactor; t__{gas}—Gas Residence Time in Reactor; f—Discharge Frequency; L/D—Length Over Diameter Ratio; D/L—Diameter Over Length Ration; q—Specific Energy Input; PR—Production Rate; GM—Gap per Module; NM—Number of Modules; P—Total Power of Reactor; NG—Number of Gaps; V—Total Volume of Gaps; M—Total Mass of Gaps; D_w—Width of Reactor Device; D_l—Length of Reactor Device; and D_h—Height of Reactor Device.

Without being bound by theory, in any of the above processes or embodiments, liquid hydrocarbon materials with a high carbon content may be cleaved into molecules having a lower carbon content, to form hydrocarbon fractions that are lighter (in terms of both molecular weight and boiling point) on average than the heavier liquid hydrocarbon materials in the feedstock. Again, without being bound by theory, it is believed that the splitting of the heavy molecules occurs via the severing of C—C bonds. For these molecules, the energy required to break a C—C bond is approximately 261.9 kJ/mol. This energy amount is significantly less than the energy required to break a C—H bond (364.5 kJ/mol).

The free radicals of hydrocarbons attract hydrogen atoms. The carrier gas may thus be provided in the process to serve as a hydrogen atom source. Suitable carrier gases, may include, but are not limited to, hydrogen-atom-containing gases. Illustrative carrier gases may include, but are not limited to, hydrogen, methane, natural gas, and other gaseous hydrocarbons. In any of the above embodiments, a mixture of such illustrative carrier gases may be employed.

Where the process is to be run continuously, the various stages or steps of the process may occur simultaneously or sequentially, such that the liquid hydrocarbon material is continuously fed to the discharge chamber as the product hydrocarbon fractions are exited from the chamber.

As set forth above, example processes may include generating a spark discharge plasma into a jet of gas in the inter-electrode discharge gap. The breakdown voltage of the carrier gas will be less than the breakdown voltage of the liquid, accordingly, the use of a jet of gas can be used at the same voltage level to generate longer discharge gap. Increasing the inter-electrode discharge gap, while reducing the corrosion effects of the process on the electrodes, increases the area of direct contact between the plasma discharge and treated liquid hydrocarbon material. Without wishing to be bound by any particular theory, it is believed that upon contact of the discharge plasma with the liquid hydrocarbon material in the inter-electrode discharge gap, the liquid hydrocarbon material may rapidly heat and evaporate to form a vapor. Thus, molecules of the liquid hydrocarbon material may be mixed with the carrier gas molecules and particles of the plasma formed therein. The plasma electrons may collide with the hydrocarbon molecules, thereby breaking them down into smaller molecules having one unsaturated bond, and being essentially free radicals, i.e. fragments of molecules having a free bond. Free radicals may also arise as a result of the direct interaction of fast-moving electrons with the liquid walls formed around the plasma channel set up between the electrodes.

As noted above, various carrier gases known in the art can be used in the processes and apparatuses of the present technology. Exemplary carrier gases include, but are not limited to, helium, neon, argon, xenon, and hydrogen (H₂), among other gases. In some embodiments, the carrier gas is a hydrogen-containing gas, such as, but not limited to, water, steam, pure hydrogen, methane, natural gas or other gaseous hydrocarbons. Mixtures of any two or more such hydrogen-containing gases may be used in any of the described embodiment. Further, non-hydrogen containing gases, such as helium, neon, argon, and xenon may be used either as diluent gases for any of the hydrogen-containing gases, or they may be used with the liquid hydrocarbon materials, thus allowing the free radicals to terminate with one another instead of with a hydrogen atom from the carrier gas. From the standpoint of energy costs for the formation of one free hydrogen atom, in order to select a suitable carrier gas, the dissociation energy of various carrier or hydrogen-containing gases may be compared. Thus, for example, breaking the bond between the hydrogen atoms in a molecule of H₂ may require about 432 kJ/mol. For water vapor, the energy required to liberate a hydrogen atom is about 495 kJ/mol, whereas for removal of a hydrogen atom from a hydrocarbon molecule such as methane, about 364.5 kJ/mol may be required.

According to certain embodiments, carrier gas is methane. The use of methane, or natural gas, is beneficial not only in terms of the energy required to break bonds, but also due to its relatively low cost. By using methane, it is ensured that C—H bonds are broken to generate a hydrogen radical and a methyl radical, either of which may combine with larger hydrocarbon radicals in a termination step. In some embodiments, the carrier gas is methane, or a mixture of methane with an inert gas such as helium, argon, neon, or xenon.

Various types of electric discharges can be used to produce plasma in the gas jet. These discharges can be either in a continuous mode, or in a pulsed mode. For example, in some embodiments, use of continuous discharges, such as an arc discharge or a glow discharge, is effective. However, use of this type of discharge for cracking heavy hydrocarbons may be limited by the fact that heating of the gaseous medium by continuous current may lead to undesirable increases in the temperature inside the discharge chamber. Such increases in temperature may lead to increased coking and soot production. Further, where a continuous discharge is used, the hydrocarbon fraction products may be continually exposed to the discharge until they pass out of the plasma. In contrast, the use of a pulsed discharge, particularly pulsed spark discharge, may be desirable for the purpose of light hydrocarbon fraction production from heavy oil fractions, because the interval between pulses may allows for termination of the free radicals and allow time for the product light hydrocarbons to exit the plasma.

In another aspect, an apparatus is provided for the conversion of a liquid hydrocarbon medium to a hydrocarbon fraction product. The apparatus may include a discharge chamber for housing the elements to provide a spark discharge for causing the conversion. The discharge chamber, and hence the apparatus, may include an inlet configured to convey the liquid hydrocarbon material to the discharge chamber, an outlet configured to convey a hydrocarbon fraction product from the discharge chamber, a negative electrode having a first end and a second end, and a positive electrode having a first end and a second end. In the discharge chamber, the first end of the negative electrode may be spaced apart from the first end of the positive electrode by a distance, the distance defining an inter-electrode discharge gap. To provide for a manner of mixing of the liquid hydrocarbon material with a carrier gas, as described above, the discharge chamber may also include a gas jet configured to introduce the carrier gas proximally to the discharge gap. In other words, the carrier gas may be injected into the liquid hydrocarbon material at, or just prior to, injection into the discharge gap. The second end of the negative electrode and the second end of the positive electrode may be connected to a capacitor, and a power supply may be provided and configured to generate the spark discharge in the inter-electrode discharge gap.

In the discharge chamber, a spark discharge may be formed in the inter-electrode discharge gap when the voltage (V) applied to the electrodes is equal to, or greater than, the breakdown voltage (V_{b}) of the inter-electrode gap. The spark discharge may be initiated by free electrons, which usually appear on the positive electrode by field emission or by other processes of electron emission. The free electrons may be accelerated into the electric field spanning the gap, and a spark plasma channel may be generated as the gas in the gap is ionized. After forming a spark discharge channel, a current of discharge may flow through the plasma. The voltage within the plasma channel (V_{d}) may be lower than the breakdown voltage (V_{b}). An arc discharge may be generated if the power supply is sufficient for the current in the discharge channel to flow in a continuous mode. The heating of the plasma may also occur in the spark discharge. However, the temperature can be controlled not only by adjusting the intensity of the discharge current, but also by controlling the duration of the discharge. In certain embodiments, as a result of the plasma channel created in the gas, the gas temperature can reach several thousand ° C.

Alternatively, a different power scheme may be used to generate the spark discharge. In some embodiments, a large variety of different pulse generators may be used to ignite the spark discharges. For example, a circuit discharging a pre-charge storage capacitor on load may be used. The parameters of the pulse voltage at the load are determined by the storage capacity as well as the parameters of the whole of the discharge circuit. The energy losses will depend on the characteristics of the discharge circuit, in particular loss into the switch.

In some embodiments of the present technology, a spark switch may be directly used as the load, i.e., plasma reactor, thereby reducing energy losses in the discharge circuit. Further, the storage capacitor can be connected in parallel to the spark gap on the circuit with minimum inductance. The breakdown of the gap may occur when the voltage on storage capacitor reaches the breakdown voltage, and the energy input into the plasma spark may occur during the discharge of the capacitor. Consequently, energy losses in the circuit are low.

According to various embodiments, the positive and negative electrodes may be shaped as flat electrodes, either as a sheet, a blade, or a flat terminal, and/or as tube-shaped electrodes (i.e. cannulated). A cannulated electrode is a hollow electrode through which the carrier gas may be injected into the liquid hydrocarbon material at the inter-electrode gap. Thus, a cannulated electrode may serve as a conduit for the carrier gas. Where the negative electrode is cannulated, the passage of the cannula may have a radius of curvature at the opening of the tube. The height or length of discharge electrode is usually measured from the base that is the point of attachment, to the top. In some embodiments, the ratio of the radius of curvature to the height or length of the cathode can be greater than about 10.

As noted above, the inter-electrode discharge gap, i.e. the distance between the two electrodes, influences the efficiency of the process. The inter-electrode discharge gap is a feature that is amenable to optimization based upon, for example, the particular hydrocarbon material fed to the discharge chamber, the injected carrier gas, and the applied voltage and/or current. However, some ranges for the inter-electrode discharge gap may be set forth. For example, in any of the above embodiments, the inter-electrode discharge gap may be from about 1-3 to about 100 millimeters. This may include an inter-electrode discharge gap from about 3 to about 20 millimeters, by using the operating voltage of 30-50 kV the optimum gap length will be 8 to 12 millimeters. The negative electrode and the positive electrode may both project into the discharge chamber.

As noted, the storage capacitor may be charged to a voltage equal to, or greater than, the breakdown voltage of the carrier gas, such that a spark discharge is produced. In some embodiments, the discharge occurs between the positive electrode and the carrier gas proximal to the first end of the positive electrode. In some embodiments, the discharge is continuous. In other embodiments, the discharge is pulsed. In some embodiments, the rate of electric discharge is regulated by the value of resistance in the charging circuit of the storage capacitor.

A power supply may be connected to the entire system to provide energy input for driving the discharge. In some embodiments, a DC power supply with an operating voltage of 15-25 kV can be used in the device described herein. The power source may depend on the number of gaps for processing of hydrocarbon liquid, on their length, pulse repetition rate, liquid flow rate through the reactor, the gas flow rate through each gap, etc. An example of a device that uses 12 gaps may include a reactor which utilizes discharge gaps of 3.5 mm length, capacitors by 100 pF capacity, operating voltage 18 kV and a pulse repetition rate of 5 Hz. The power supply consumed can range from 1 to 2 watts, while the plasma can absorb a power of about 0.97 watts directly in the discharge. The remaining energy may be dissipated in the charging system capacitors.

An HV insulator can be placed at the bottom aligned with the reactor with plastic screws. Its function is to prevent electrical between the bottom electrodes to ensure spark happens on at the reaction zones. Additional O rings or gaskets might also needed between the reactor and the HV insulator to prevent unwanted discharges. Fig.

The apparatus and processes thus generally described above, will be understood by reference to the following examples, which are not intended to be limiting of the apparatus or processes described above in any manner.

### EXAMPLES

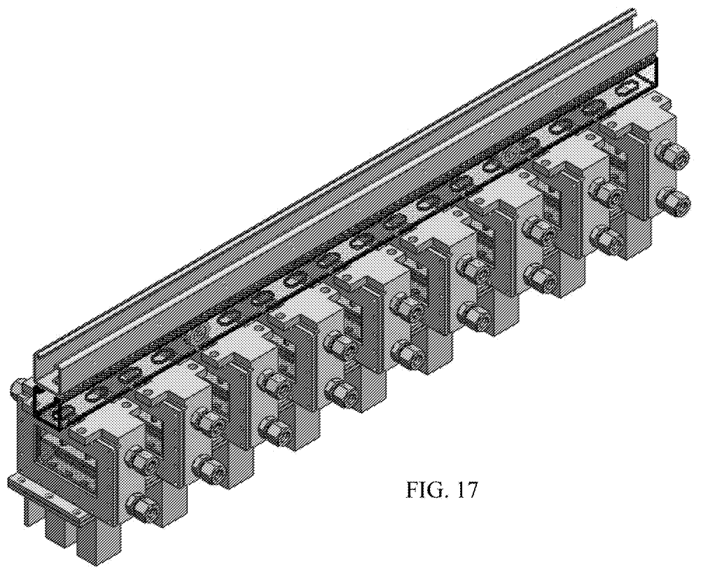

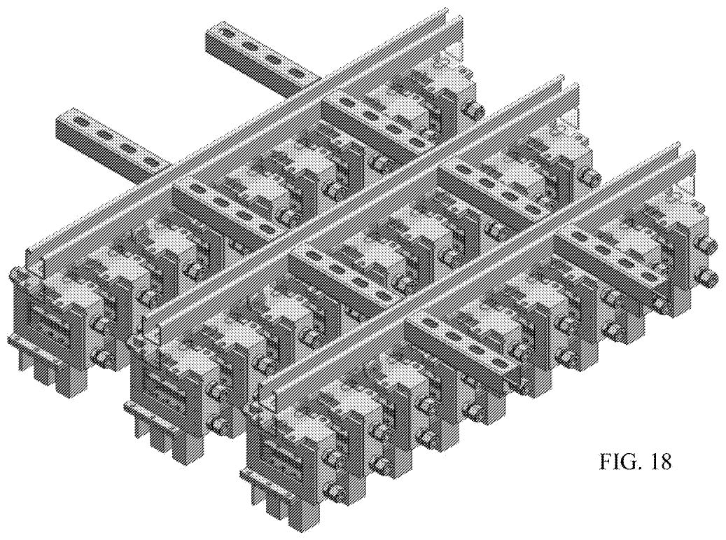

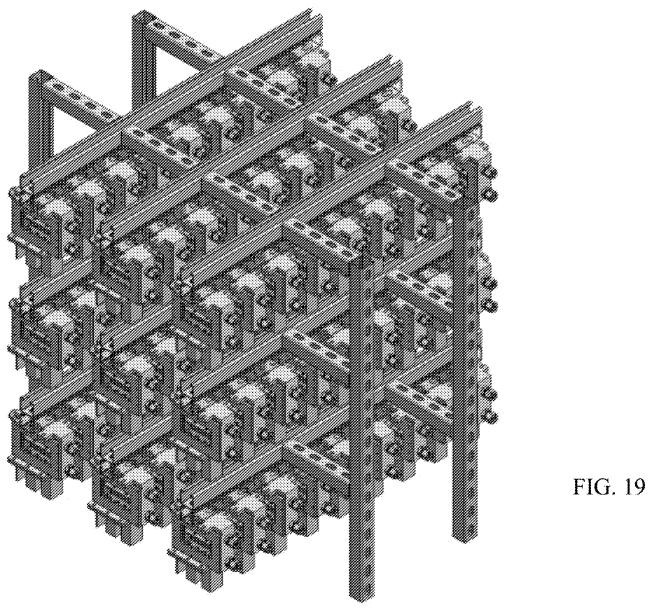

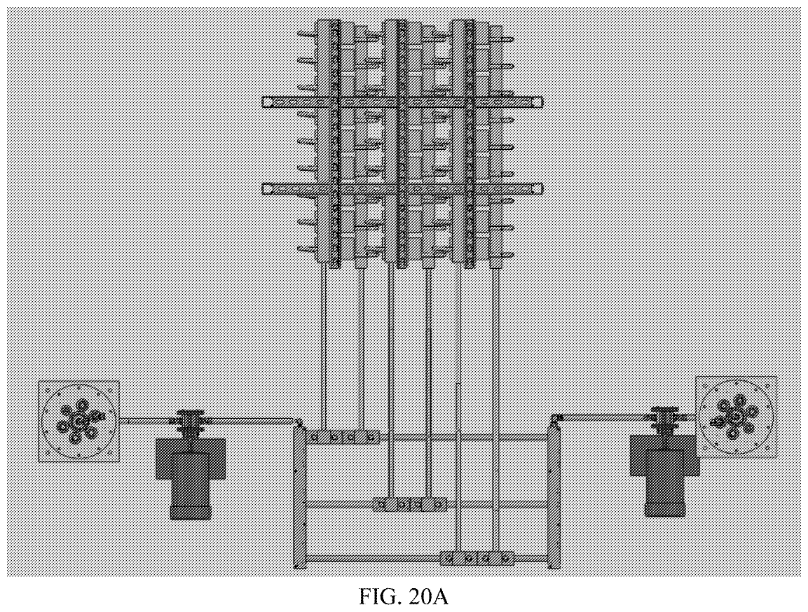

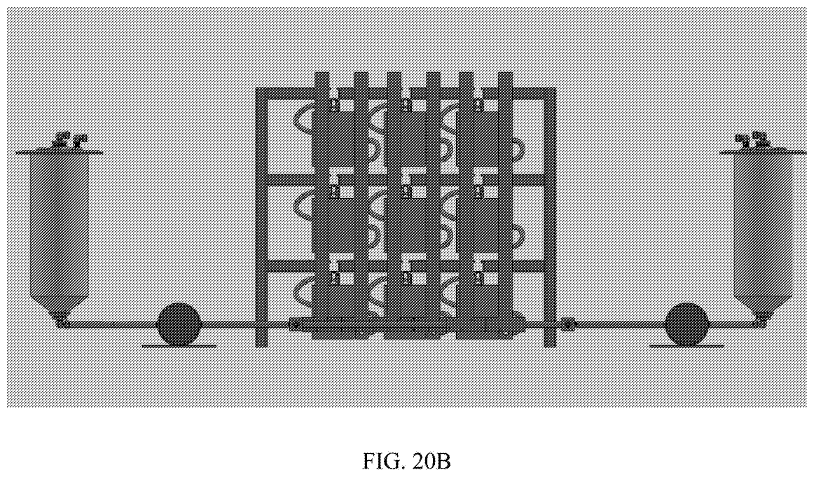

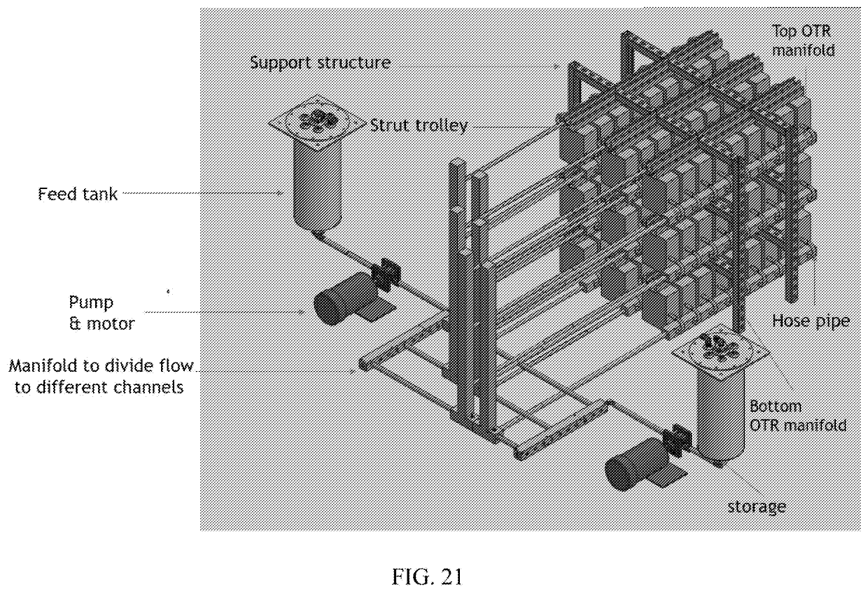

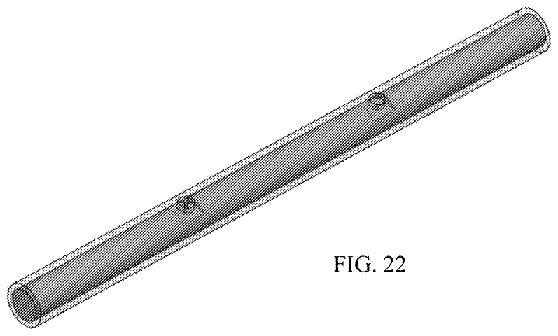

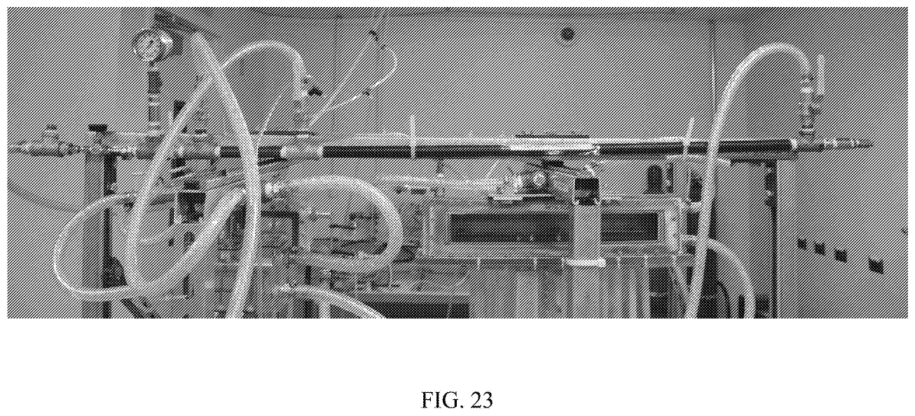

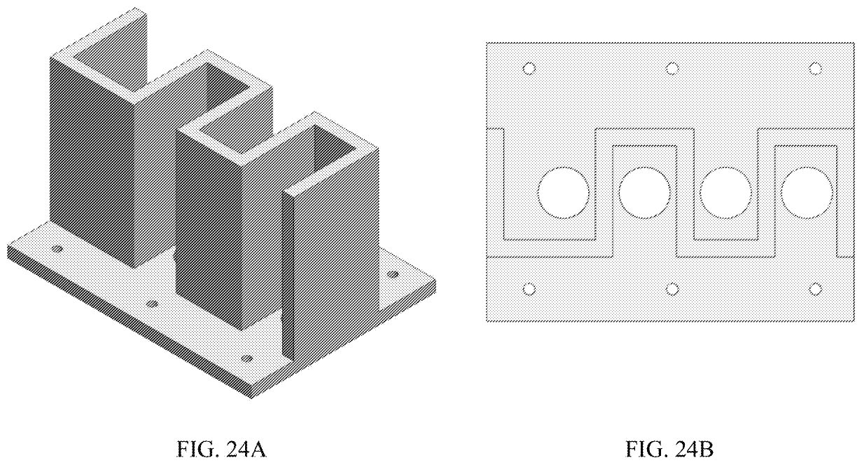

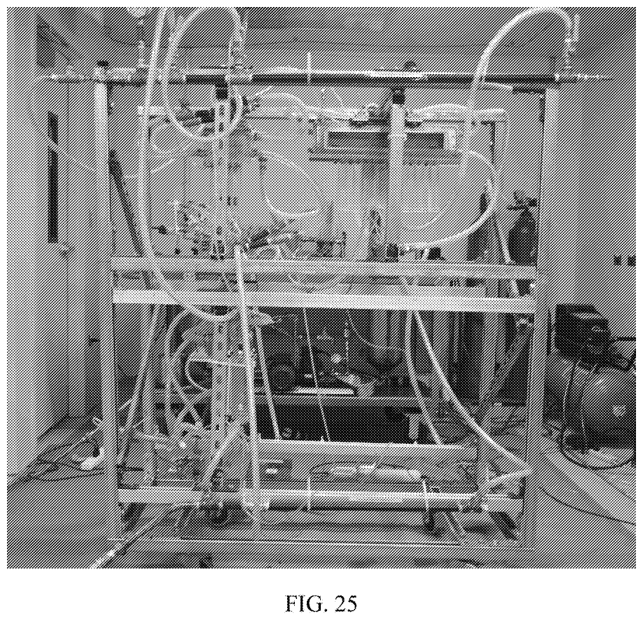

FIG. 17 shows 9 modules in a module rack, each module containing 4 plasma reactions zone. The module rack is vertically arranged with 2 other racks to form a 3×3 module arrays. 3 module arrays are arranged to make a 3×3×3 module matrix. This system has a total of 324 plasma reaction zones, 81 modules, 9 module racks, and 3 module arrays.

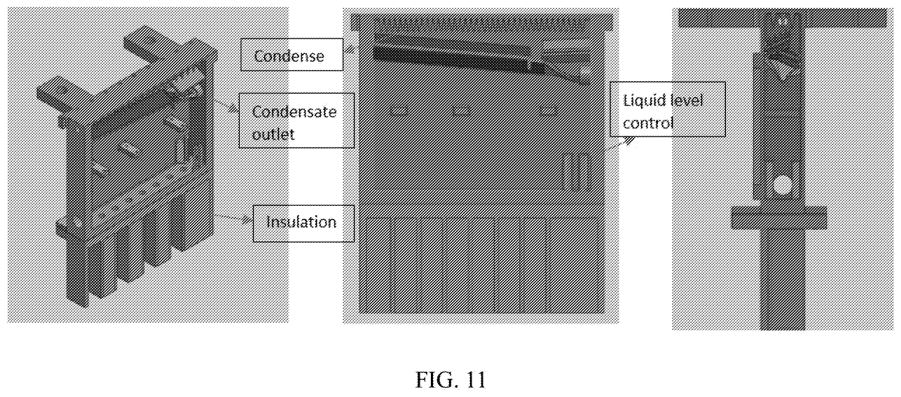

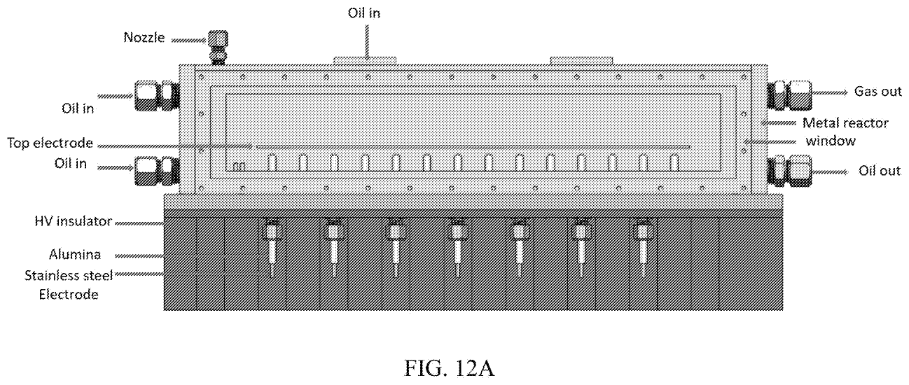

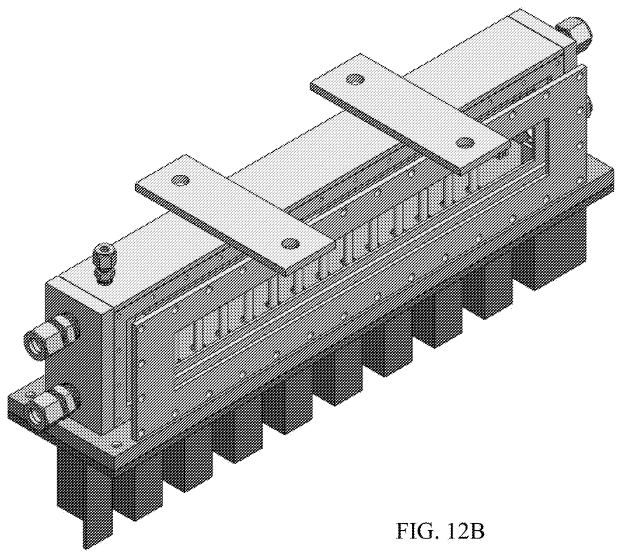

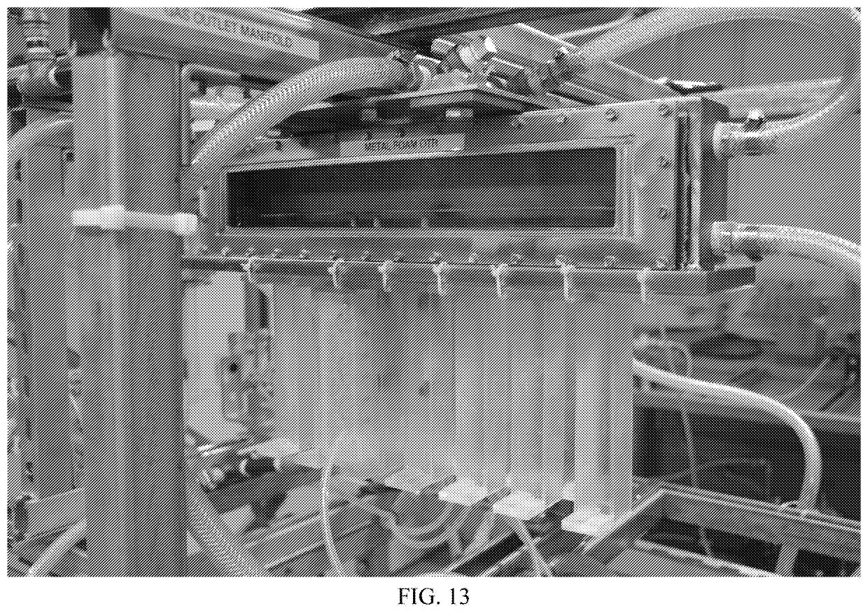

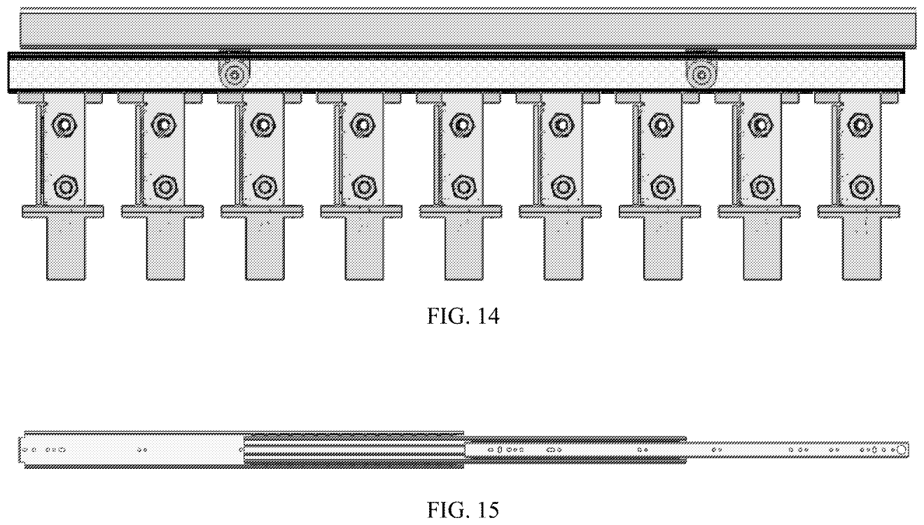

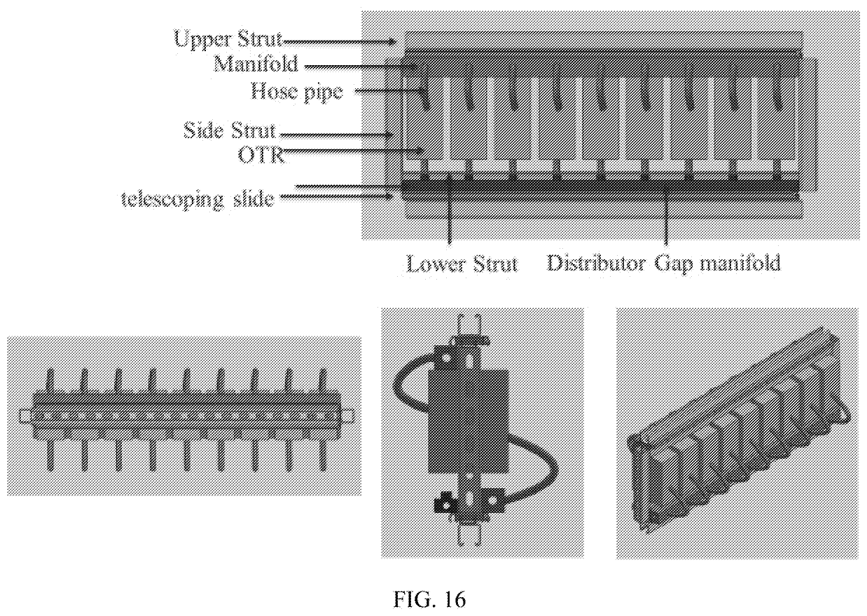

FIG. 11 shows a module with an integrated light product condenser. FIG. 7 shows a module without a product condenser.

FIG. 8 below is a photo of a M=4 module. FIG. 9 is a photo of a M=8 module filled with liquid, bubbles and with active discharge processing. In the background of the M=8 module is another M=8 module (made from glass) in the background. FIG. 10 shows the M=8 module with integral high voltage power supply submodule.

The invention is further defined by the following embodiments:

Embodiment A. A single spark gap scale-up method for a plasma chemical reactor for processing hydrocarbons, the method comprising: defining a set of parameters including at least one of performance indication parameters and scale indication parameters, wherein performance parameters indicate the plasma-gas and plasma-liquid interaction in the multiphase reactor, and wherein scale parameters represent the reactor space utilization efficiency and overall size; developing a single gap scale up model to enhance scale parameters; and conducting a parametric study to estimate a number of spark gaps and total mass information for the spark gaps.

Embodiment B. A method for multiple spark gap scale-up with reactor modules of a plasma chemical reactor for processing hydrocarbons, the method comprising using a plurality of reactor modules to build a three dimensional reactor matrix, wherein a resulting device includes a number of electrical discharge modules selected based on a production requirement.

Embodiment C. The method of Embodiment B, further including using the resulting device to process hydrocarbons in an oilfield or refinery.

Embodiment D. The method of Embodiment B or C, wherein the discharge modules can be assembled without onsite construction.

Embodiment E. The method of any of Embodiments B-D, wherein the discharge modules are skid or portable.

Embodiment F. The method of any of Embodiments B-E, wherein the resulting device is used independently as an oil treatment reactor or used within an oil treatment system after incorporation in the oil treatment system.

Embodiment G. The method of any of Embodiments B-F, further comprising arranging discharge modules in a reactor matrix such that a selected column or row may be turned off without turning off remaining columns or rows, respectively.

Embodiment H. The method of any of Embodiments B-G, further including connecting the reactor matrix to external fluid and electrical devices via quick connects.

Embodiment I. The method of any of Embodiments B-H, wherein each discharge module transmits sensor data to a server in real time to allow for remote diagnostics and monitoring.

Embodiment J. The method of any of Embodiments B-I, wherein gas and flow control to each discharge module is separated from other discharge modules.

Embodiment K. The method of any of Embodiments B-J, further including adding or removing a discharge module with reduced gas leak or disturbance.

Embodiment L. The method of any of Embodiments B-K, wherein liquid level may be controlled in a discharge module in a passive way.

Embodiment M. The method of any of Embodiments B-L, further including running the reactor continuously with various stages or steps of the process occurring simultaneously or sequentially, such that the liquid hydrocarbon material is continuously fed to the discharge reactor as the product hydrocarbons fractions are exited from the reactor.

Embodiment N. The method of any of Embodiments B-M, wherein the product hydrocarbons include light fractions to be separated from distillation and solids that are produced in the discharge gap but need to be removed from the product.

Embodiment O. The method of any of Embodiments B-N, wherein one or more types of oil treatment reactors (OTRs) are used to develop the matrix.

Embodiment P. A three dimensional reactor matrix for processing hydrocarbons in an oilfield or refinery, the reactor matrix comprising at least three electrical discharge modules arranged in a matrix such that a column or row of discharge modules in the matrix may be selectively turned off without turning off discharge modules not in the selected column or row.

Embodiment Q. The reactor matrix of Embodiment P, wherein the reactor matrix is configured to transmit real time information about discharge modules to a server for online diagnostics and monitoring.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The embodiments, illustratively described herein may suitably be practiced in the absence of any element or elements, limitation or limitations, not specifically disclosed herein. Thus, for example, the terms ‘comprising,’ ‘including,’ ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and processes within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into sub-ranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. (canceled)

2. A method for multiple spark gap scale-up with reactor modules of a plasma chemical reactor for processing hydrocarbons, the method comprising using a plurality of reactor modules to build a three dimensional reactor matrix, wherein a resulting device includes a number of electrical discharge modules selected based on a production requirement.

3. The method of claim 2, further including using the resulting device to process hydrocarbons in an oilfield or refinery.

4. The method of claim 2, wherein the discharge modules can be assembled without onsite construction.

5. The method of claim 2, wherein the discharge modules are skid or portable.

6. The method of claim 2, wherein the resulting device is used independently as an oil treatment reactor or used within an oil treatment system after incorporation in the oil treatment system.

7. The method of claim 2, further comprising arranging discharge modules in a reactor matrix such that a selected column or row may be turned off without turning off remaining columns or rows, respectively.

8. The method of claim 7, further including connecting the reactor matrix to external fluid and electrical devices via quick connects.

9. The method of claim 2, wherein each discharge module transmits sensor data to a server in real time to allow for remote diagnostics and monitoring.

10. The method of claim 2, wherein gas and flow control to each discharge module is separated from other discharge modules.

11. The method of claim 2, further including adding or removing a discharge module with reduced gas leak or disturbance.

12. The method of claim 2, wherein liquid level may be controlled in a discharge module in a passive way.

13. The method of claim 2, further including running the reactor continuously with various stages or steps of the process occurring simultaneously or sequentially, such that the liquid hydrocarbon material is continuously fed to the discharge reactor as the product hydrocarbons fractions are exited from the reactor.

14-15. (canceled)

16. A three dimensional reactor matrix for processing hydrocarbons in an oilfield or refinery, the reactor matrix comprising at least three electrical discharge modules arranged in a matrix such that a column or row of discharge modules in the matrix may be selectively turned off without turning off discharge modules not in the selected column or row.

17. The reactor matrix of claim 16, wherein the reactor matrix is configured to transmit real time information about discharge modules to a server for online diagnostics and monitoring.

18. The method of claim 2, wherein the three dimensional reactor matrix comprises at least three electrical discharge modules arranged in a matrix such that a column or row of discharge modules in the matrix may be selectively turned off without turning off discharge modules not in the selected column or row.

19. The method of claim 18, wherein the reactor matrix is configured to transmit real time information about discharge modules to a server for online diagnostics and monitoring, and wherein the method further comprises performing online diagnostics or monitoring based on transmissions from the server.

20. The method of claim 2, further comprising:
defining a set of parameters including at least one of performance indication parameters and scale indication parameters, wherein performance parameters indicate the plasma-gas and plasma-liquid interaction in the plasma chemical reactor, and wherein scale parameters represent a reactor space utilization efficiency and overall size;
developing a multiple gap scale up model to enhance scale parameters; and
conducting a parametric study to estimate a number of spark gaps and total mass information for the spark gaps so as to determine reactor size and number of reactors for a production rate of processed hydrocarbons.

21. The method of claim 20, wherein defining the set of parameters includes:
(A) defining at least one performance indication parameter selected from:
(i) a first performance indication parameter (r₁) corresponding to a ratio of a gas discharge volume to a total gas bubble volume in one or more gaps;
(ii) a second performance indication parameter (r₂) corresponding to a ratio of a gas phase volume to a total fluids volume in one or more gaps, wherein r₂ corresponds to a gas holdup in the one or more gaps;
(iii) a third performance indication parameter (r₅) corresponding to bubble surface area divided by total fluids volume; and
(iv) a fourth performance indication parameter (r₆) corresponding to bubble total length divided by discharge gap length; and
(B) defining at least one scale indication parameter selected from:
(i) a first scale indication parameter (r₃) corresponding to ratio of fluids volume in the reactor to the total rector volume;
(ii) a second scale indication parameter (r₄) corresponding to a ratio of fluids volume of the reactor to the unit square volume of the reactor;
(iii) a third scale indication parameter (r₇) corresponding to oil processing severity; and
(iv) a fourth scale indication parameter (r₈) corresponding to gas processing severity.

22. A single or multiple spark gap scale-up method for a plasma chemical reactor for processing hydrocarbons, the method comprising:
defining a set of parameters including at least one of performance indication parameters and scale indication parameters, wherein performance parameters indicate the plasma-gas and plasma-liquid interaction in the plasma chemical reactor, and wherein scale parameters represent a reactor space utilization efficiency and overall size;
developing a single or multiple gap scale up model to enhance scale parameters; and
conducting a parametric study to estimate a number of spark gaps and total mass information for the spark gaps so as to determine reactor size and number of reactors for a production rate of processed hydrocarbons.

23. The method of claim 22, wherein defining the set of parameters includes defining two or more of:
(i) a first performance indication parameter (r₁) corresponding to a ratio of a gas discharge volume to a total gas bubble volume in one or more gaps;
(ii) a second performance indication parameter (r₂) corresponding to a ratio of a gas phase volume to a total fluids volume in one or more gaps, wherein r₂ corresponds to a gas holdup in the one or more gaps;
(iii) a third performance indication parameter (r₅) corresponding to bubble surface area divided by total fluids volume;
(iv) a fourth performance indication parameter (r₆) corresponding to bubble total length divided by discharge gap length;
(v) a first scale indication parameter (r₃) corresponding to a ratio of fluids volume in the reactor to the total rector volume;
(vi) a second scale indication parameter (r₄) corresponding to a ratio of fluids volume of the reactor to the unit square volume of the reactor;
(vii) a third scale indication parameter (r₇) corresponding to oil processing severity; and
(viii) a fourth scale indication parameter (r₈) corresponding to gas processing severity.
